(19) United States
(12) Patent Application Publication
(10) Pub. No.: US 2015/0081725 A1
(43) Pub. Date: Mar. 19, 2015

(54) SYSTEM AND METHOD FOR ACTIVELY OBTAINING SOCIAL DATA

(71) Applicant: MARKETWIRE L.P., Toronto (CA)

(72) Inventors: Stuart OGAWA, Los Gatos, CA (US); Edward Dong-Jin KIM, Toronto (CA); Brian Jia-Lee KENG, Thornhill (CA); Kanchana PADMANABHAN, Toronto (CA)

(73) Assignee: MARKETWIRE L.P., Toronto (CA)

(21) Appl. No.: 14/323,702

(22) Filed: Jul. 3, 2014

Related U.S. Application Data
(60) Provisional application No. 61/880,027, filed on Sep. 19, 2013.

(51) Int. Cl. G06F 17/30

(52) U.S. Cl. CPC G06F 17/30699
USPC 707/754

(57) ABSTRACT

A system and method are provided for obtaining and analysing social data. The obtained social data and the determined relationships can be used to compose new social data and determine transmission parameters of the new social data. A method performed by a computing device or server system includes obtaining social data from one or more data streams, filtering the social data to obtain filtered social data, analysing the filtered social data to determine one or more relationships, and outputting the filtered social data and the one or more relationships in association with each other.

### CROSS-REFERENCE TO RELATED APPLICATIONS

This application claims priority from United States Provisional Patent Application No. 61/880,027, filed on Sep. 19, 2013 and titled “System and Method for Continuous Social Communication”, the entire contents of which are incorporated herein by reference.

### TECHNICAL FIELD

The following generally relates to obtaining social data.

### BACKGROUND

In recent years social media has become a popular way for individuals and consumers to interact online (e.g. on the Internet). Social media also affects the way businesses aim to interact with their customers, fans, and potential customers online.

There are many different types of social media (e.g. articles, online posts, blogs, comments, pictures, videos, audio data, etc.). The sources of the data also vary as there are many persons, groups and organizations generating the social data. Obtaining this data efficiently and understanding the relationships between these different types of data, the different parties, and the meanings of the data can be difficult.

### BRIEF DESCRIPTION OF THE DRAWINGS

Embodiments will now be described by way of example only with reference to the appended drawings wherein:

FIG. 1 is a block diagram of a social communication system interacting with the Internet or a cloud computing environment, or both.

FIG. 2 is a block diagram of an example embodiment of a computing system for social communication, including example components of the computing system.

FIG. 3 is a block diagram of an example embodiment of multiple computing devices interacting with each other over a network to form the social communication system.

FIG. 4 is a schematic diagram showing the interaction and flow of data between an active receiver module, an active composer module, an active transmitter module and a social analytic synthesizer module.

FIG. 5 is a flow diagram of an example embodiment of computer executable or processor implemented instructions for composing new social data and transmitting the same.

FIG. 6 is a block diagram of an active receiver module showing example components thereof.

FIG. 7 is a flow diagram of an example embodiment of computer executable or processor implemented instructions for receiving social data.

FIG. 8 is a flow diagram of an example embodiment of computer executable or processor implemented instructions for determining topics in which a given user is considered an expert.

FIG. 9 is a flow diagram of an example embodiment of computer executable or processor implemented instructions for determining topics in which a given user is interested.

FIG. 10 is a flow diagram of an example embodiment of computer executable or processor implemented instructions for analysing topics.

FIG. 11 is a flow diagram of an example embodiment of computer executable or processor implemented instructions for searching for experts of a topic.

FIG. 12 is a flow diagram of an example embodiment of computer executable or processor implemented instructions for identifying experts in topic A that have interest in topic B.

FIG. 13 is a flow diagram of an example embodiment of computer executable or processor implemented instructions for identifying user that interest in a topic.

FIG. 14 is a flow diagram of an example embodiment of computer executable or processor implemented instructions for suggesting followers for a specific user account that have interest in a topic.

FIG. 15 is a schematic diagram of users following each other in a social data network.

FIG. 16 is a flow diagram of an example embodiment of computer executable or processor implemented instructions for identifying influencers and their communities.

FIG. 17 is a flow diagram of another example embodiment of computer executable or processor implemented instructions for identifying influencers and their communities.

FIG. 18 is a schematic diagram of a topic network of users related to a specific topic.

FIG. 19 is a schematic diagram of the topic network of FIG. 18, but showing different groups within the topic network.

FIG. 20 is a flow diagram of another example embodiment of computer executable or processor implemented instructions for identifying and filtering outliers in a topic network.

FIG. 21 is a flow diagram of another example embodiment of computer executable or processor implemented instructions for ranking influencers.

FIG. 22 is a flow diagram of another example embodiment of computer executable or processor implemented instructions for identifying segments of users based on a topic.

FIG. 23 is a flow diagram of another example embodiment of computer executable or processor implemented instructions for identifying segments of users based on a topic.

FIG. 24 is a flow diagram of an example embodiment of computer executable or processor implemented instructions for identifying segments of users based on a topic, using n-gram processing of text.

FIG. 25 is a flow diagram of an example embodiment of computer executable or processor implemented instructions for selectively obtaining data specific to a certain parameter.

FIG. 26 is a flow diagram of an example embodiment of computer executable or processor implemented instructions for filtering and amplifying features in the obtained social data.

FIG. 27 is a flow diagram of an example embodiment of computer executable or processor implemented instructions for filtering out noise in the obtained social data.

FIG. 28 is a flow diagram of an example embodiment of computer executable or processor implemented instructions for correlating location and topic data.

FIG. 29 is a flow diagram of an example embodiment of computer executable or processor implemented instructions for obtaining and combining data from different data sources.

FIG. 30 is a flow diagram of another example embodiment of computer executable or processor implemented instructions for obtaining and combining data from different data sources.

FIG. 31 is a flow diagram of an example embodiment of computer executable or processor implemented instructions for obtaining data from different data sources and comparing the same for verification.

FIG. 32 is a flow diagram of an example embodiment of computer executable or processor implemented instructions for predicting or synthesizing data, or both.

FIG. 33 is a block diagram of an active composer module showing example components thereof.

FIG. 34A is a flow diagram of an example embodiment of computer executable or processor implemented instructions for composing new social data.

FIG. 34B is a flow diagram of an example embodiment of computer executable or processor implemented instructions for combining social data according to an operation described in FIG. 34A.

FIG. 34C is a flow diagram of an example embodiment of computer executable or processor implemented instructions for extracting social data according to an operation described in FIG. 34A.

FIG. 34D is a flow diagram of an example embodiment of computer executable or processor implemented instructions for creating social data according to an operation described in FIG. 34A.

FIG. 35 is a block diagram of an active transmitter module showing example components thereof.

FIG. 36 is a flow diagram of an example embodiment of computer executable or processor implemented instructions for transmitting the new social data.

FIG. 37 is a block diagram of a social analytic synthesizer module showing example components thereof.

FIG. 38 is a flow diagram of an example embodiment of computer executable or processor implemented instructions for determining adjustments to be made for any of the processes implemented by the active receiver module, the active composer module, and the active transmitter module.

### DETAILED DESCRIPTION OF THE DRAWINGS

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

The proposed systems and methods described herein relate to obtaining or receiving social data. The obtained or received social data can be used in, for example, but is not limited to, the context of continuous social communication. In other words, the system architecture and operations related to the active receiver module, described below, may be used in isolation or with other systems not described here.

Social data herein refers to content able to be viewed or heard, or both, by people over a data communication network, such as the Internet. Social data includes, for example, text, video, graphics, and audio data, or combinations thereof. Examples of text include blogs, emails, messages, posts, articles, comments, etc. For example, text can appear on websites such as Facebook, Tumblr, Twitter, LinkedIn, Pinterest, Instagram, other social networking websites, magazine websites, newspaper websites, company websites, blogs, etc. Text may also be in the form of comments on websites, text provided in an RSS feed, etc. Examples of video can appear on Facebook, YouTube, news websites, personal websites, blogs (also called vlogs), company websites, etc. Graphical data, such as pictures, can also be provided through the above mentioned outlets. Audio data can be provided through various websites, such as those mentioned above, audio-casts, “Pod casts”, online radio stations, etc. It is appreciated that social data can vary in form.

A social data object herein refers to a unit of social data, such as a text article, a video, a comment, a message, an audio track, a graphic, or a mixed-media social piece that includes different types of data. A stream of social data includes multiple social data objects. For example, in a string of comments from people, each comment is a social data object. In another example, in a group of text articles, each article is a social data object. In another example, in a group of videos, each video file is a social data object. Social data includes at least one social data object.

It is recognized that effective social communication, from a business perspective, is a significant challenge. The expansive reach of digital social sites, such as Twitter, Facebook, YouTube, etc., the real time nature of communication, the different languages used, and the different communication modes (e.g. text, audio, video, etc.) make it challenging for businesses to effectively listen to and communicate with their customers. The increasing number of websites, channels, and communication modes can overwhelm businesses with too much real time data and little appropriate and relevant information. It is also recognized that people in decision making roles in business are often left wondering who is saying what, what communication channels are being used, and which people are important to listen to.

It is recognized that typically a person or persons generate social data. For example, a person generates social data by writing a message, an article, a comment, etc., or by generating other social data (e.g. pictures, video, and audio data). This generation process, although sometimes partially aided by a computer, is time consuming and uses effort by the person or persons. For example, a person typically types in a text message, and inputs a number of computing commands to attach a graphic or a video, or both. After a person creates the social data, the person will need to distribute the social data to a website, a social network, or another communication channel. This is also a time consuming process that requires input from a person.

It is also recognized that when a person generates social data, before the social data is distributed, the person does not have a way to estimate how well the social data will be received by other people. After the social data has been distributed, a person may also not have a way to evaluate how well the content has been received by other people. Furthermore, many software and computing technologies require a person to view a website or view a report to interpret feedback from other people.

It is also recognized that generating social data that is interesting to people, and identifying which people would find the social data interesting is a difficult process for a person, and much more so for a computing device. Computing technologies typically require input from a person to identify topics of interest, as well as identify people who may be interested in a topic. It also recognized that generating large amounts of social data covering many different topics is a difficult and time-consuming process. Furthermore, it is difficult achieve such a task on a large data scale within a short time frame.

It is also recognized that obtaining social data and understanding the relationships between social data is difficult, given the volume of data and different meanings of the social data. For example, given a large volume of data, it is recognized that quickly receiving and processing the received data is difficult. It is also recognized that identifying relationships between users and data (e.g. topics, keywords, etc.) is difficult, since, for example, the interactions between users and the data may not be predefined. Other relationships, such as location and topic, may also be skipped over. It also recognized that receiving relevant data particular to a goal or a set of criteria is difficult.

Aspects of the proposed systems and methods described herein address one or more of these above issues. Aspects of the proposed systems and methods use one or more computing devices to receive social data, identify relationships between the social data, compose new social data based on the identified relationships and the received social data, and transmit the new social data. In a preferred example embodiment, these systems and methods are automated and require no input from a person for continuous operation. In another example embodiment, some input from a person is used to customize operation of these systems and methods.

Aspects of the proposed systems and methods are able to obtain feedback during this process to improve computations related to any of the operations described above. For example, feedback is obtained about the newly composed social data, and this feedback can be used to adjust parameters related to where and when the newly composed social data is transmitted. This feedback is also used to adjust parameters used in composing new social data and to adjust parameters used in identifying relationships. Further details and example embodiments regarding the proposed systems and methods are described below.

Aspects of the proposed systems and methods may be used for real time listening, analysis, content composition, and targeted broadcasting. The systems, for example, capture global data streams of data in real time. The stream data is analyzed and used to intelligently determine content composition and intelligently determine who, what, when, and how the composed messages are to be sent.

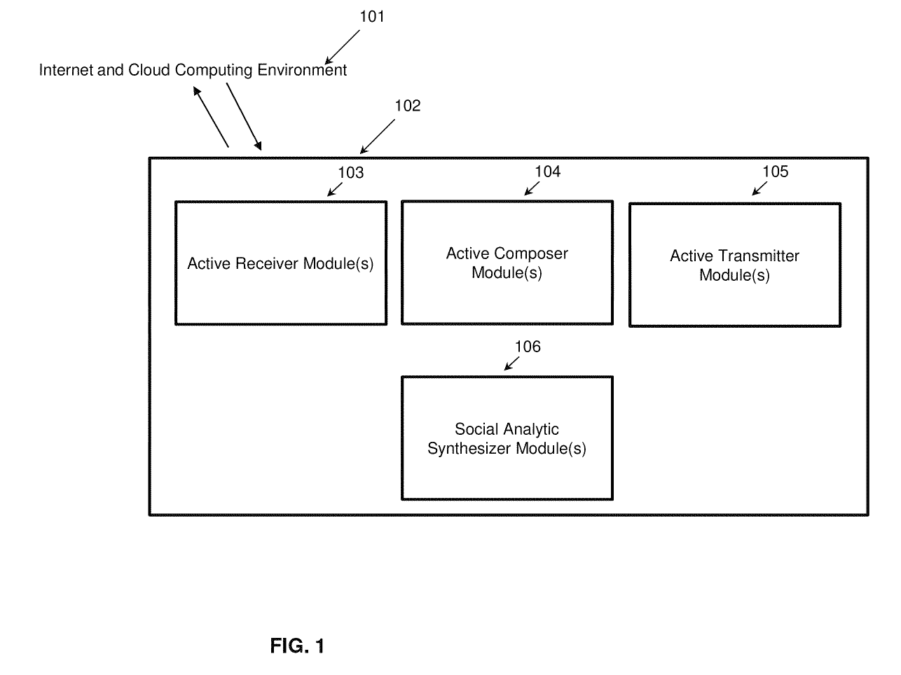

Turning to FIG. 1, the proposed continuous social communication system 102 includes an active receiver module 103, an active composer module 104, an active transmitter module 105, and a social analytic synthesizer module 106. The system 102 is in communication with the Internet or a cloud computing environment, or both 101. The cloud computing environment may be public or may be private. In an example embodiment, these modules function together to receive social data, identify relationships between the social data, compose new social data based on the identified relationships and the received social data, and transmit the new social data.

The active receiver module 103 receives social data from the Internet or the cloud computing environment, or both. The active receiver module 103 is able to simultaneously receive social data from many data streams. The active receiver module 103 also analyses the received social data to identify relationships amongst the social data. Units of ideas, people, location, groups, companies, words, number, or values are herein referred to as concepts. The active receiver module 103 identifies at least two concepts and identifies a relationship between the at least two concepts. For example, the active receiver module identifies relationships amongst originators of the social data, the consumers of the social data, and the content of the social data. The receiver module 103 outputs the identified relationships.

The active composer module 104 uses the relationships and social data to compose new social data. For example, the composer module 104 modifies, extracts, combines, or synthesizes social data, or combinations of these techniques, to compose new social data. The active composer module 104 outputs the newly composed social data. Composed social data refers to social data composed by the system 102.

The active transmitter module 105 determines appropriate communication channels and social networks over which to send the newly composed social data. The active transmitter module 105 is also configured receive feedback about the newly composed social data using trackers associated with the newly composed social data.

The social analytic synthesizer module 106 obtains data, including but not limited to social data, from each of the other modules 103, 104, 105 and analyses the data. The social analytic synthesizer module 106 uses the analytic results to generate adjustments for one or more various operations related to any of the modules 103, 104, 105 and 106.

In an example embodiment, there are multiple instances of each module. For example, multiple active receiver modules 103 are located in different geographic locations. One active receiver module is located in North America, another active receiver module is located in South America, another active receiver module is located in Europe, and another active receiver module is located in Asia. Similarly, there may be multiple active composer modules, multiple active transmitter modules and multiple social analytic synthesizer modules. These modules will be able to communicate with each other and send information between each other. The multiple modules allows for distributed and parallel processing of data. Furthermore, the multiple modules positioned in each geographic region may be able to obtain social data that is specific to the geographic region and transmit social data to computing devices (e.g. computers, laptops, mobile devices, tablets, smart phones, wearable computers, etc.) belonging to users in the specific geographic region. In an example embodiment, social data in South America is obtained within that region and is used to compose social data that is transmitted to computing devices within South America. In another example embodiment, social data is obtained in Europe and is obtained in South America, and the social data from the two regions are combined and used to compose social data that is transmitted to computing devices in North America.

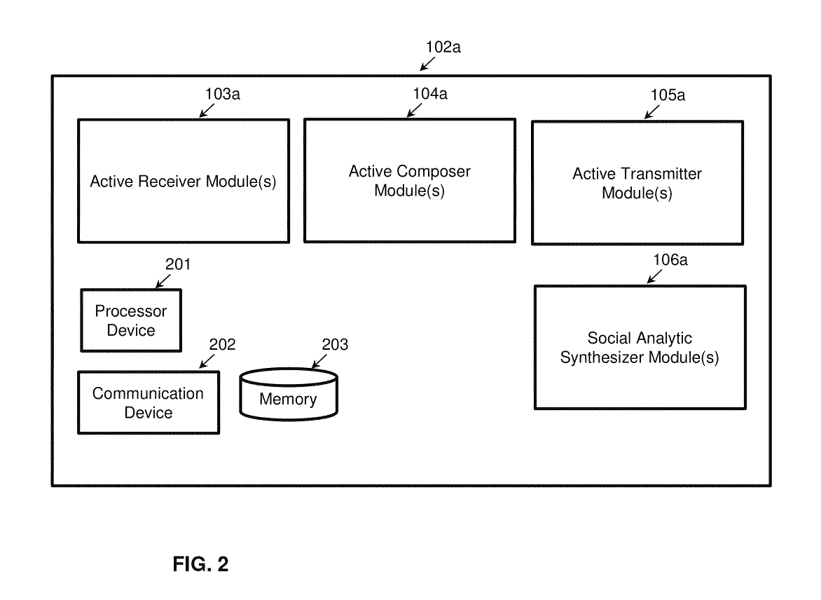

Turning to FIG. 2, an example embodiment of a system 102a is shown. For ease of understanding, the suffix “a” or “b”, etc. is used to denote a different embodiment of a previously described element. The system 102a is a computing device or a server system and it includes a processor device 201, a communication device 202 and memory 203. The communication device is configured to communicate over wired or wireless networks, or both. The active receiver module 103a, the active composer module 104a, the active transmitter module 105a, and the social analytic synthesizer module 106a are implemented by software and reside within the same computing device or server system 102a. In other words, the modules may share computing resources, such as for processing, communication and memory.

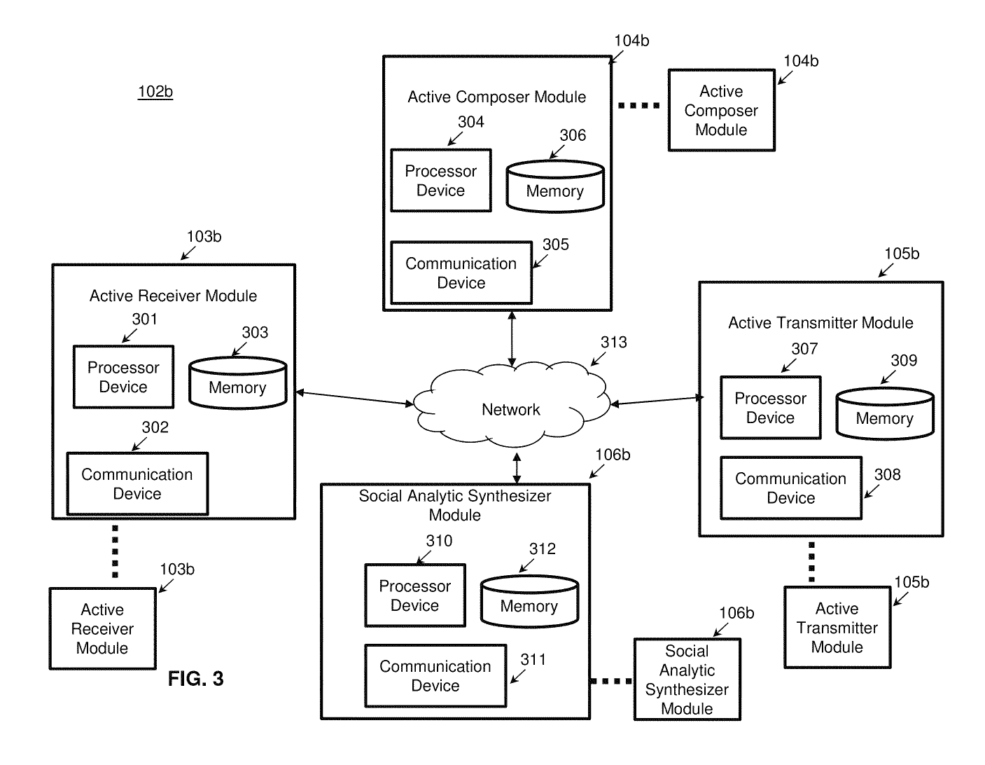

Turning to FIG. 3, another example embodiment of a system 102b is shown. The system 102b includes different modules 103b, 104b, 105b, 106b that are separate computing devices or server systems configured to communicate with each other over a network 313. In particular, the active receiver module 103b includes a processor device 301, a communication device 302, and memory 303. The active composer module 104b includes a processor device 304, a communication device 305, and memory 306. The active transmitter module 105b includes a processor device 307, a communication device 308, and memory 309. The social analytic synthesizer module 106b includes a processor device 310, a communication device 311, and memory 312.

Although only a single active receiver module 103b, a single active composer module 104b, a single active transmitter module 105b and a single social analytic synthesizer module 106b are shown in FIG. 3, it can be appreciated that there may be multiple instances of each module that are able to communicate with each other using the network 313. As described above with respect to FIG. 1, there may be multiple instances of each module and these modules may be located in different geographic locations.

It can be appreciated that there may be other example embodiments for implementing the computing structure of the system 102.

It is appreciated that currently known and future known technologies for the processor device, the communication device and the memory can be used with the principles described herein. Currently known technologies for processors include multi-core processors. Currently known technologies for communication devices include both wired and wireless communication devices. Currently known technologies for memory include disk drives and solid state drives. Examples of the computing device or server systems include dedicated rack mounted servers, desktop computers, laptop computers, set top boxes, and integrated devices combining various features. A computing device or a server uses, for example, an operating system such as Windows Server, Mac OS, Unix, Linux, FreeBSD, Ubuntu, etc.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the system 102, or any or each of the modules 103, 104, 105, 106, or accessible or connectable thereto. Any application or module herein described may be implemented using computer readable/executable instructions that may be stored or otherwise held by such computer readable media.

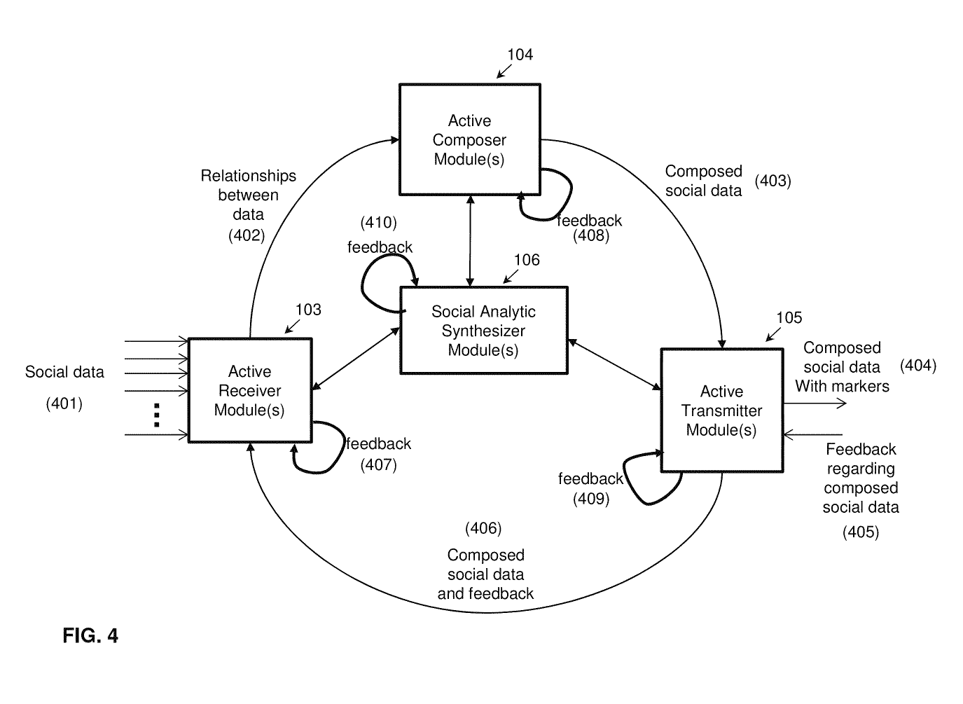

Turning to FIG. 4, the interactions between the modules are shown. The system 102 is configured to listen to data streams, compose automated and intelligent messages, launch automated content, and listen to what people are saying about the launched content.

In particular, the active receiver module 103 receives social data 401 from one or more data streams. The data streams can be received simultaneously and in real-time. The data streams may originate from various sources, such as Twitter, Facebook, YouTube, LinkedIn, Pinterest, blog websites, news websites, company websites, forums, RSS feeds, emails, social networking sites, etc. The active receiver module 103 analyzes the social data, determines or identifies relationships between the social data, and outputs these relationships 402.

In a particular example, the active receiver module 103 obtains social data about a particular car brand and social data about a particular sports team from different social media sources. The active receiver 103 uses analytics to determine there is a relationship between the car brand and the sports team. For example, the relationship may be that buyers or owners of the car brand are fans of the sports team. In another example, the relationship may be that there is a high correlation between people who view advertisements of the car brand and people who attend events of the sports team. The one or more relationships are outputted.

The active composer module 104 obtains these relationships 402 and obtains social data corresponding to these relationships. The active composer module 104 uses these relationships and corresponding data to compose new social data 403. The active composer module 104 is also configured to automatically create entire messages or derivative messages, or both. The active composer module 104 can subsequently apply analytics to recommend an appropriate, or optimal, message that is machine-created using various social data geared towards a given target audience.

Continuing with the particular example, the active composer module 104 composes a new text article by combining an existing text article about the car brand and an existing text article about the sports team. In another example, the active composer module composes a new article about the car brand by summarizing different existing articles of the car brand, and includes advertisement about the sports team in the new article. In another example, the active composer module identifies people who have generated social data content about both the sports team and the car brand, although the social data for each topic may be published at different times and from different sources, and combines this social content together into a new social data message. In another example embodiment, the active composer module may combine video data and/or audio data related to the car brand with video data and/or audio data related to the sports team to compose new video data and/or audio data. Other combinations of data types can be used.

The active transmitter module 105 obtains the newly composed social data 403 and determines a number of factors or parameters related to the transmission of the newly composed social data. The active transmitter module 105 also inserts or adds markers to track people's responses to the newly composed social data. Based on the transmission factors, the active transmitter module transmits the composed social data with the markers 404. The active transmitter module is also configured to receive feedback regarding the composed social data 405, in which collection of the feedback includes use of the markers. The newly composed social data and any associated feedback 406 are sent to the active receiver module 103.

Continuing with the particular example regarding the car brand and the sports team, the active transmitter module 105 determines trajectory or transmission parameters. For example, social networks, forums, mailing lists, websites, etc. that are known to be read by people who are interested in the car brand and the sports team are identified as transmission targets. Also, special events, such as a competition event, like a game or a match, for the sports team are identified to determine the scheduling or timing for when the composed data should be transmitted. Location of targeted readers will also be used to determine the language of the composed social data and the local time at which the composed social data should be transmitted. Markers, such as number of clicks, number of forwards, time trackers to determine length of time the composed social data is viewed, etc., are used to gather information about people's reaction to the composed social data. The composed social data related to the car brand and the sports team and associated feedback are sent to the active receiver module 103.

Continuing with FIG. 4, the active receiver module 103 receives the composed social data and associated feedback 406. The active receiver module 103 analyses this data to determine if there are any relationships or correlations. For example, the feedback can be used to determine or affirm that the relationship used to generate the newly composed social data is correct, or is incorrect.

Continuing with the particular example regarding the car brand and the sports team, the active receiver module 103 receives the composed social data and the associated feedback. If the feedback shows that people are providing positive comments and positive feedback about the composed social data, then the active receiver module determines that the relationship between the car brand and the sports team is correct. The active receiver module may increase a rating value associated with that particular relationship between the car brand and the sports team. The active receiver module may mine or extract even more social data related to the car brand and the sports team because of the positive feedback. If the feedback is negative, the active receiver module corrects or discards the relationship between the car brand and the sports team. A rating regarding the relationship may decrease. In an example embodiment, the active receiver may reduce or limit searching for social data particular to the car brand and the sports team.

Periodically, or continuously, the social analytic synthesizer module 106 obtains data from the other modules 103, 104, 105. The social analytic synthesizer module 106 analyses the data to determine what adjustments can be made to the operations performed by each module, including module 106. It can be appreciated that by obtaining data from each of modules 103, 104 and 105, the social analytic synthesizer has greater contextual information compared to each of the modules 103, 104, 105 individually.

Continuing with the particular example regarding the car brand and the sports team, the social analytic synthesizer module 106 obtains data that people are responding positively to the newly composed social data object in a second language different than a first language used in the newly composed social data object. Such information can be obtained from the active transmitter module 105 or from the active receiver module 103, or both. Therefore, the social analytic synthesizer module sends an adjustment command to the active composer module 104 to compose new social data about the car brand and the sports team using the second language.

In another example, the social analytic synthesizer module 106 obtains data that positive feedback, about the newly composed social data object regarding the car brand and the sports team, is from a particular geographical vicinity (e.g. a zip code, an area code, a city, a municipality, a state, a province, etc.). This data can be obtained by analyzing data from the active receiver module 103 or from the active transmitter module 105, or both. The social analytic synthesizer then generates and sends an adjustment command to the active receiver module 103 to obtain social data about that particular geographical vicinity. Social data about the particular geographical vicinity includes, for example, recent local events, local jargon and slang, local sayings, local prominent people, and local gathering spots. The social analytic synthesizer generates and sends an adjustment command to the active composer module 104 to compose new social data that combines social data about the car brand, the sports team and the geographical vicinity. The social analytic synthesizer generates and sends an adjustment command to the active transmitter module 105 to send the newly composed social data to people located in the geographical vicinity, and to send the newly composed social data during time periods when people are likely to read or consume such social data (e.g. evenings, weekends, etc.).

Continuing with FIG. 4, each module is also configured to learn from its own gathered data and to improve its own processes and decision making algorithms. Currently known and future known machine learning and machine intelligence computations can be used. For example, the active receiver module 103 has a feedback loop 407; the active composer module 104 has a feedback loop 408; the active transmitter module 105 has a feedback loop 409; and the social analytic synthesizer module has a feedback loop 410. In this way, the process in each module can continuously improve individually, and also improve using the adjustments sent by the social analytic synthesizer module 106. This self-learning on a module-basis and system-wide basis allows the system 102 to be completely automated without human intervention.

It can be appreciated that as more data is provided and as more iterations are performed by the system 102 for sending composed social data, then the system 102 becomes more effective and efficient.

Other example aspects of the system 102 are described below.

The system 102 is configured to capture social data in real time.

The system 102 is configured to analyze social data relevant to a business or, a particular person or party, in real time.

The system 102 is configured to create and compose social data that is targeted to certain people or a certain group, in real time.

The system 102 is configured to determine the best or appropriate times to transmit the newly composed social data.

The system 102 is configured to determine the best or appropriate social channels to reach the selected or targeted people or groups.

The system 102 is configured to determine what people are saying about the new social data sent by the system 102.

The system 102 is configured to apply metric analytics to determine the effectiveness of the social communication process.

The system 102 is configured to determine and recommend analysis techniques and parameters, social data content, transmission channels, target people, and data scraping and mining processes to facilitate continuous loop, end-to-end communication.

The system 102 is configured to add N number of systems or modules, for example, using a master-slave arrangement.

It will be appreciated that the system 102 may perform other operations.

In an example embodiment, computer or processor implemented instructions, which are implemented by the system 102, for providing social communication includes obtaining social data. The system then composes a new social data object derived from the social data. It can be appreciated that the new social data object may have exactly the same content of the obtained social data, or a portion of the content of the obtained social data, or none of the content of the obtained social data. The system transmits the new social data object and obtains feedback associated with the new social data object. The system computes an adjustment command using the feedback, wherein executing the adjustment command adjusts a parameter used in the operations performed by the system.

In an example embodiment, the system obtains a social data object using the active receiver module, and the active composer module passes the social data object to the active transmitter module for transmission. Computation and analysis is performed to determine if the social data object is suitable for transmission, and if so, to which party and at which time should the social data object be transmitted.

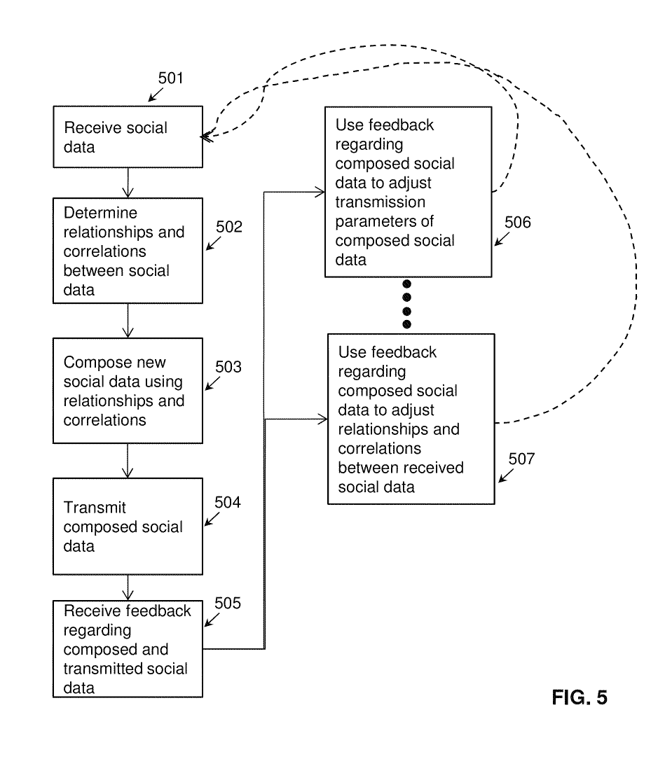

Another example embodiment of computer or processor implemented instructions is shown in FIG. 5 for providing social communication. The instructions are implemented by the system 102. At block 501, the system 102 receives social data. At block 502, the system determines relationships and correlations between social data. In an example embodiment, new metadata can be created from the social ingested data, such as but not limited to relationships and correlations. At block 503, the system composes new social data using the relationships and the correlations. At block 504, the system transmits the composed social data. At block 505, the system receives feedback regarding the composed social data. At block 506, following block 505, the system uses the feedback regarding the composed social data to adjust transmission parameters of the composed social data. In addition, or in the alternative, at block 507, following block 505, the system uses the feedback regarding the composed social data to adjust relationships and correlations between the received social data. It can be appreciated that other adjustments can be made based on the feedback. As indicated by the dotted lines, the process loops back to block 501 and repeats.

### Active Receiver Module

The active receiver module 103 automatically and dynamically listens to N number of global data streams and is connected to Internet sites or private networks, or both. The active receiver module may include analytic filters to eliminate unwanted information, machine learning to detect valuable information, and recommendation engines to quickly expose important conversations and social trends. New meta data may also be created from the social ingested data, such as but not limited to relationships and correlations. Further, the active receiver module is able to integrate with other modules, such as the active composer module 104, the active transmitter module 105, and the social analytic synthesizer module 106.

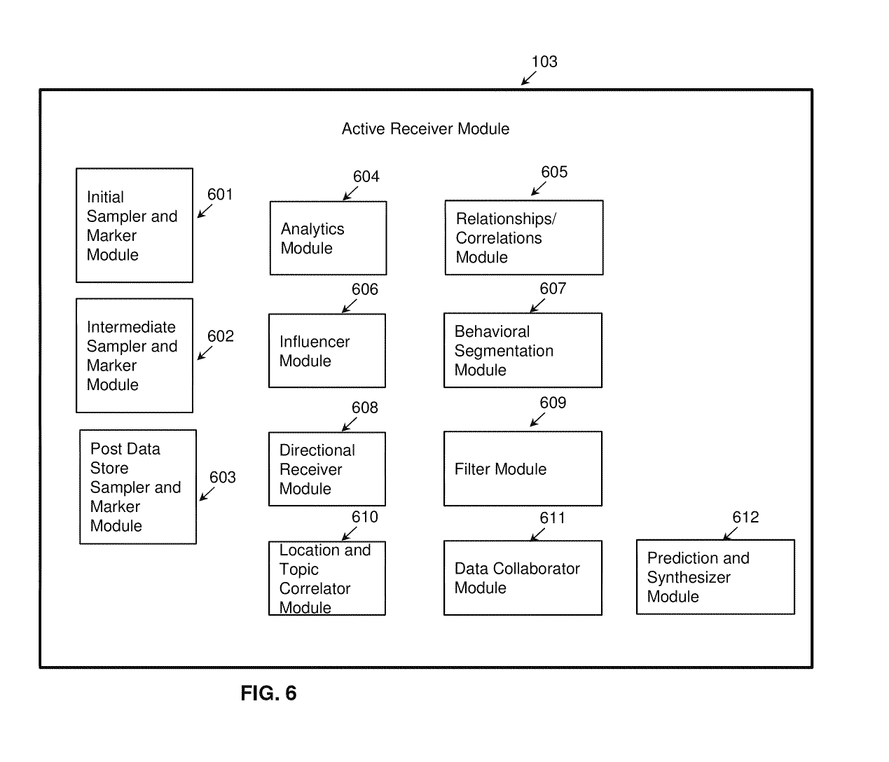

Turning to FIG. 6, example components of the active receiver module 103 are shown. The example components include an initial sampler and marker module 601, an intermediate sampler and marker module 602, a post-data-storage sampler and marker module 603, an analytics module 604, a relationships/correlations module 605, an influencer module 606, a behavioral segmentation module 607, a directional receiver module 608, a filter module 609, a location and topic correlator module 610, a data collaborator module 611 and a prediction and synthesizer module 612. It will be appreciated that the modules within the active receiver 103 may exchange data with each other.

In an example embodiment, module 601 provides real time analytics, module 602 provides near real time analytics, and module 603 provides batched analytics. This is referred to as, for example, social streaming analytics.

To facilitate real-time and efficient analysis of the obtained social data, different levels of speed and granularity are used to process the obtained social data. The module 601 is used first to initially sample and mark the obtained social data at a faster speed and lower sampling rate. This allows the active receiver module 103 to provide some results in real-time. The module 602 is used to sample and mark the obtained data at a slower speed and at a higher sampling rate relative to module 601. This allows the active receiver module 103 to provide more detailed results derived from module 602, although with some delay compared to the results derived from module 601. The module 603 samples all the social data stored by the active receiver module at a relatively slower speed compared to module 602, and with a much higher sampling rate compared to module 602. This allows the active receiver module 103 to provide even more detailed results which are derived from module 603, compared to the results derived from module 602. It can thus be appreciated, that the different levels of analysis can occur in parallel with each other and can provide initial results very quickly, provide intermediate results with some delay, and provide post-data-storage results with further delay.

The sampler and marker modules 601, 602, 603 also identify and extract other data associated with the social data including, for example: the time or date, or both, that the social data was published or posted; hashtags; a tracking pixel; a web bug, also called a web beacon, tracking bug, tag, or page tag; a cookie; a digital signature; a keyword; user and/or company identity associated with the social data; an IP address associated with the social data; geographical data associated with the social data (e.g. geo tags); entry paths of users to the social data; certificates; users (e.g. followers) reading or following the author of the social data; users that have already consumed the social data; etc. This data may be used by the active receiver module 103 and/or the social analytic synthesizer module 106 to determine relationships amongst the social data.

The analytics module 604 can use a variety of approaches to analyze the social data and the associated other data. The analysis is performed to determine relationships, correlations, affinities, and inverse relationships. Non-limiting examples of algorithms that can be used include artificial neural networks, nearest neighbor, Bayesian statistics, decision trees, regression analysis, fuzzy logic, K-means algorithm, clustering, fuzzy clustering, the Monte Carlo method, learning automata, temporal difference learning, apriori algorithms, the ANOVA method, Bayesian networks, and hidden Markov models. More generally, currently known and future known analytical methods can be used to identify relationships, correlations, affinities, and inverse relationships amongst the social data. The analytics module 604, for example, obtains the data from the modules 601, 602, and/or 603.

It will be appreciated that inverse relationships between two concepts, for example, is such that a liking or affinity to first concept is related to a dislike or repelling to a second concept.

The relationships/correlations module 605 uses the results from the analytics module to generate terms and values that characterize a relationship between at least two concepts. The concepts may include any combination of keywords, time, location, people, video data, audio data, graphics, etc.

The relationships module 605 can also identify keyword bursts. The popularity of a keyword, or multiple keywords, is plotted as a function of time. The analytics module identifies and marks interesting temporal regions as bursts in the keyword popularity curve. The analytics module identifies one or more correlated keywords associated with the keyword of interest (e.g. the keyword having a popularity burst). The correlated keyword is closely related to the keyword of interest at the same temporal region as the burst. Such a process is described in detail in U.S. patent application Ser. No. 12/501,324, filed on Jul. 10, 2009 and titled “Method and System for Information Discovery and Text Analysis”, the entire contents of which are incorporated herein by reference.

In an example embodiment, searching for and analysing data, such as one or more text sources and temporally-ordered data objects, includes: providing access to one or more text sources, each text source including one or more temporally-ordered data objects; obtaining or generating a search query based on one or more terms and one or more time intervals; obtaining or generating time data associated with the data objects; identifying one or more data objects based on the search query; and generating one or more popularity curves based on the frequency of data objects corresponding to one or more of the search terms in the one or more time intervals.

In another example aspect, the method further includes: analysing data objects within the one or more popularity curves; and defining one or more data objects as data objects of interest based on fluctuations in the popularity curve indicating a high frequency of data objects corresponding to one or more search terms. In another example aspect, the method further includes generating one or more additional terms associated with the data objects of interest. In another example aspect, the method further includes generating and submitting a search query automatically based upon one or more specific data objects, or one or more obtained terms, and one or more terms generated by a prior search query. In another example aspect, the generating of the search query based upon one or more specific data objects further includes extracting query terms from the one or more specified data objects by way of an algorithmic methodology. In another example aspect, the method includes ranking the data objects and additional terms associated with data objects of interest, characterized in that the ranking orders the data objects and additional terms associated with the data objects of interest in accordance with the authoritative nature of the data object as indicated by the data associated with the data object establishing that a data object is frequently referenced by users. In another example aspect, the method further includes including in the search query one or more of: one or more geographical search terms, or one or more demographic search terms. In another example aspect, the one or more popularity curves are based upon sentiment analysis derived through assigning user sentiment data to each data object, either positive or negative, by defining or obtaining positive or negative terms relating to the data objects, inferring the sentiment data from the presence or absence of such positive or negative terms, and based on such sentiment data defining additional information for a search query. In another example aspect, the popularity curve fluctuations are drill down and roll-up capable.

In another example aspect, the relationships module 605 can also identify relationships between topics (e.g. keywords) and users that are interested in the keyword. The relationships module, for example, can identify a user who is considered an expert in a topic. If a given user regularly comments on a topic, and there many other users who “follow” the given user, then the given user is considered an expert. The relationships module can also identify in which other topics that an expert user has an interest, although the expert user may not be considered an expert of those other topics. The relationships module can obtain a number of ancillary users that a given user follows; obtain the topics in which the ancillary users are considered experts; and associate those topics with the given user. It can be appreciated that there are various ways to correlate topics and users together. Further details are described in U.S. Patent Application No. 61/837,933, filed on Jun. 21, 2013 and titled “System and Method for Analysing Social Network Data”, the entire contents of which are incorporated herein by reference.

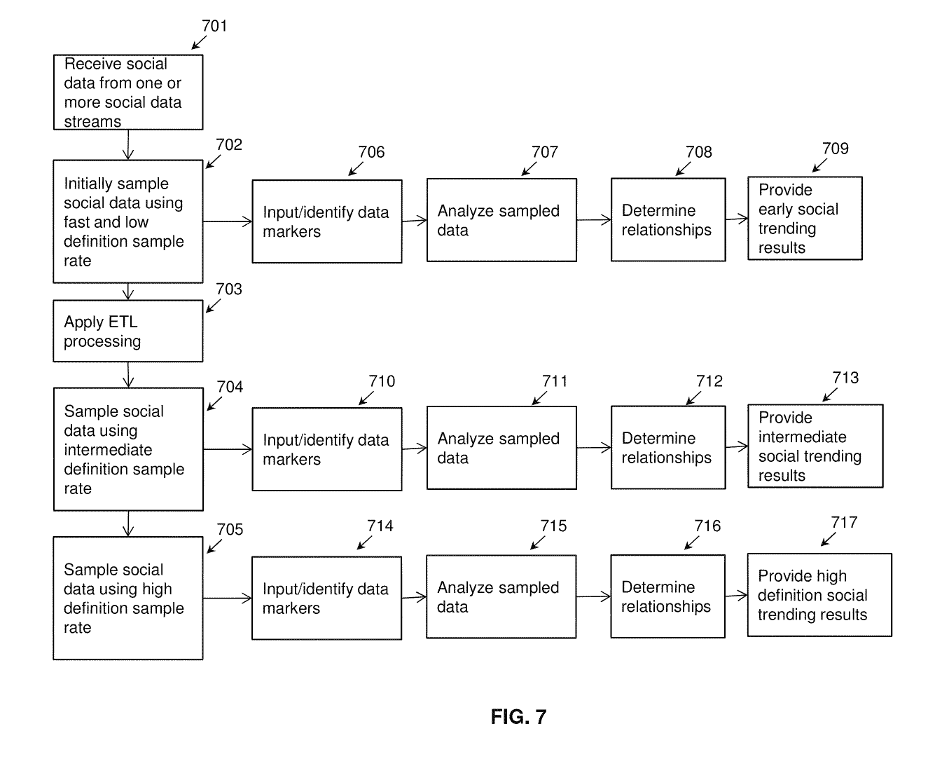

Turning to FIG. 7, example computer or processor implemented instructions are provided for receiving and analysing data according to the active receiver module 103. At block 701, the active receiver module receives social data from one or more social data streams. At block 702, the active receiver module initially samples the social data using a fast and low definition sample rate (e.g. using module 601). At block 703, the active receiver module applies ETL (Extract, Transform, Load) processing. The first part of an ETL process involves extracting the data from the source systems. The transform stage applies a series of rules or functions to the extracted data from the source to derive the data for loading into the end target. The load phase loads the data into the end target, such as the memory.

At block 704, the active receiver module samples the social data using an intermediate definition sample rate (e.g. using 601). At block 705, the active receiver module samples the social data using a high definition sample rate (e.g. using module 603). In an example embodiment, the initial sampling, the intermediate sampling and the high definition sampling are performed in parallel. In another example embodiment, the samplings occur in series.

Continuing with FIG. 7, after initially sampling the social data (block 702), the active receiver module inputs or identifies data markers (block 706). It proceeds to analyze the sampled data (block 707), determine relationships from the sampled data (block 708), and use the relationships to determine early or initial social trending results (block 709).

Similarly, after block 704, the active receiver module inputs or identifies data markers in the sampled social data (block 710). It proceeds to analyze the sampled data (block 711), determine relationships from the sampled data (block 712), and use the relationships to determine intermediate social trending results (block 713).

The active receiver module also inputs or identifies data markers in the sampled social data (block 714) obtained from block 705. It proceeds to analyze the sampled data (block 715), determine relationships from the sampled data (block 716), and use the relationships to determine high definition social trending results (block 717).

In an example embodiment, the operations at block 706 to 709, the operations at block 710 to 713, and the operations at block 714 to 717 occur in parallel. The relationships and results from blocks 708 and 709, however, would be determined before the relationships and results from blocks 712, 713, 716 and 717.

It will be appreciated that the data markers described in blocks 706, 710 and 714 assist with the preliminary analysis and the sampled data and also help to determine relationships. Example embodiments of data markers include keywords, certain images, and certain sources of the data (e.g. author, organization, location, network source, etc.). The data markers may also be tags extracted from the sampled data.

In an example embodiment, the data markers are identified by conducting a preliminary analysis of the sampled data, which is different from the more detailed analysis in blocks 707, 711 and 715. The data markers can be used to identify trends and sentiment.

In another example embodiment, data markers are inputted into the sampled data based on the detection of certain keywords, certain images, and certain sources of data. A certain organization can use this operation to input a data marker into certain sampled data. For example, a car branding organization inputs the data marker “SUV” when an image of an SUV is obtained from the sampling process, or when a text message has at least one of the words “SUV”, “Jeep”, “4×4”, “CR-V”, “Rav4”, and “RDX”. It can be appreciated that other rules for inputting data markers can be used. The inputted data markers can also be used during the analysis operations and the relationship determining operations to detect trends and sentiment.

With respect to the relationships and correlations module 605, further details is provided for identifying users who are experts on a topic, and are able to identify users with an interest on a topic. As used herein, the term “expert” refers to a user account that primarily produces and shares content related to a topic and has a wide following of users. The term “follower”, as used herein, refers to a first user account (e.g. the first user account associated with one or more social networking platforms accessed via a computing device) that follows a second user account (e.g. the second user account associated with at least one of the social networking platforms of the first user account and accessed via a computing device), such that content posted by the second user account is published for the first user account to read, consume, etc. For example, when a first user follows a second user, the first user (i.e. the follower) will receive content posted by the second user. A user with an “interest” on a particular topic herein refers to a user account that follows a number of experts in the particular topic. In some cases, a follower engages with the content posted by the other user (e.g. by sharing or reposting the content).

It can be appreciated that the social data further includes the user account ID or user name, a description of the user or user account, the messages or other data posted by the user, connections between the user and other users, location information, etc. An example of connections is a “user list”, also herein called “list”, which includes a name of the list, a description of the list, and one or more other users which the given user follows. The user list is created by the given user.

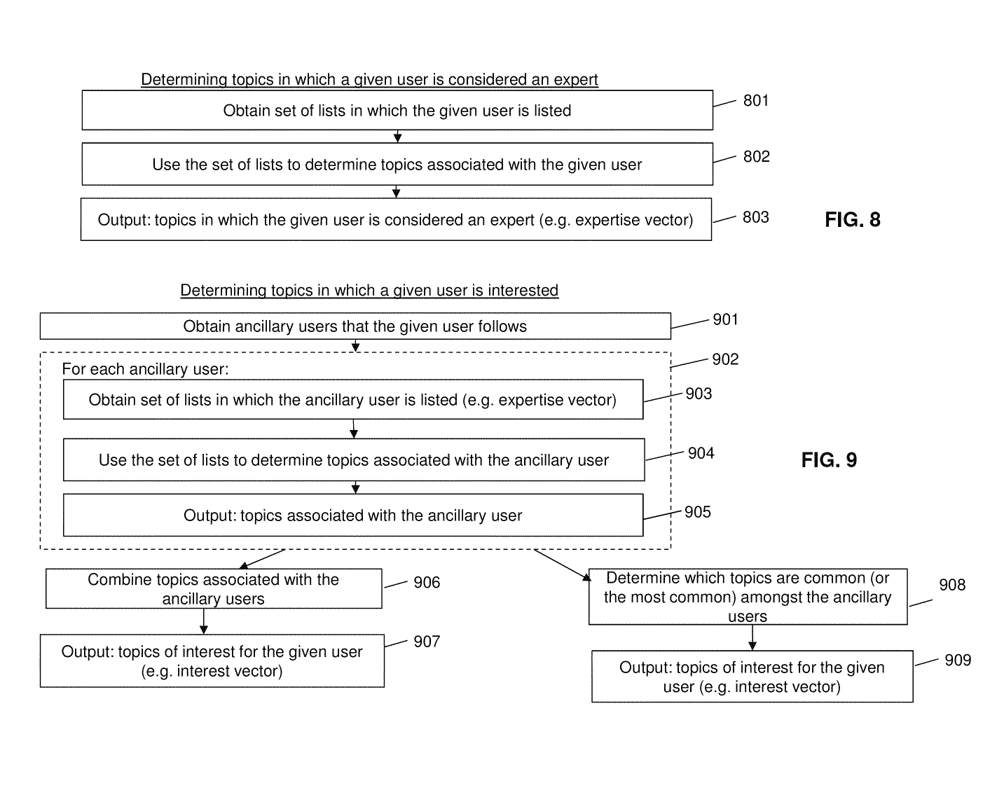

Turning to FIG. 8, an example embodiment of computer executable instructions is provided for determining topics for which a given user is considered an expert. At block 801, the active receiver 103 obtains a set of lists in which the given user listed. At block 802, the active receiver 103 uses the set of lists to determine topics associated with the given user. At block 803, the active receiver 103 outputs the topics in which the given user is considered an expert. These topics form the expertise vector of the given user. For example, if the user Alice is listed in Bob's fishing list, Celine's art list, and David's photography list, then Alice's expertise vector includes: fishing, art and photography.

In an example embodiment, the user lists are obtained by constantly crawling them, since the user lists are dynamically updated by users, and new lists are created often. In an example embodiment, the user lists are processed using an Apache Lucene index. The expertise vector of a given user is processed using the Lucene algorithm to populate the index of topics associated with the given user. This index supports, for example, full Lucene query syntax, including phrase queries and Boolean logic. By way of background, Apache Lucene is an information retrieval software library that is suitable for full text indexing and searching. Lucene is also widely known for its use in the implementation of Internet search engines and local single-site searching. It can be appreciated, that other currently known or future known searching and indexing algorithms can be used.

Turning to FIG. 9, an example embodiment of computer executable instructions is provided for determining topics in which a given user is interested. At block 901, the active receiver 103 obtains ancillary users that the given user follows.

At block 902, a number of instructions are performed, but specific to each ancillary user. In particular, at block 903, the active receiver obtains a set of lists in which the ancillary user is listed (e.g. the expertise vector of the ancillary user). At block 904, the active receiver uses the set of lists to determine topics associated with the ancillary user. The outputs of block 904 are topics associated with the ancillary user (block 905). In an example embodiment, block 902 can simply call on the algorithm presented in FIG. 8, but being applied to each ancillary user.

In an example embodiment, at block 906, the active receiver combines the topics from all the ancillary users. The combined topics form the output 907 of the topics of interest for the given user (e.g. the interest vector of the given user).

In another example embodiment, an alternative to the blocks 906 and 907 is to determine which topics are common, or most common amongst the ancillary users (block 908). For example, a given user Alice, follows ancillary users Bob, Celine and David. Bob is considered an expert in fishing and photography (e.g. the expertise vector of Bob). Celine is considered an expert in fishing, photography and art (e.g. the expertise vector of Celeine). David is considered an expert in fishing and music (e.g. the expertise vector of David). Therefore, since the topic of fishing is common amongst all the ancillary users, it is identified that Alice has an interest in the topic of fishing. Or, since photography is more common amongst the ancillary users (e.g. the second most common topic after fishing), then the topic of photography is also identified as a topic of interest for Alice. Since art and music are not common amongst the ancillary users, these topics are not considered to be topics interest to Alice. These common, or most common, topics are outputted, for example, as an interest vector for the given user (block 909).

In an example embodiment, the data from the expertise vector and the data from interest vector are supplied to the Lucene algorithm for indexing, or are processed using another indexing algorithm, and are stored in an index store (not shown).

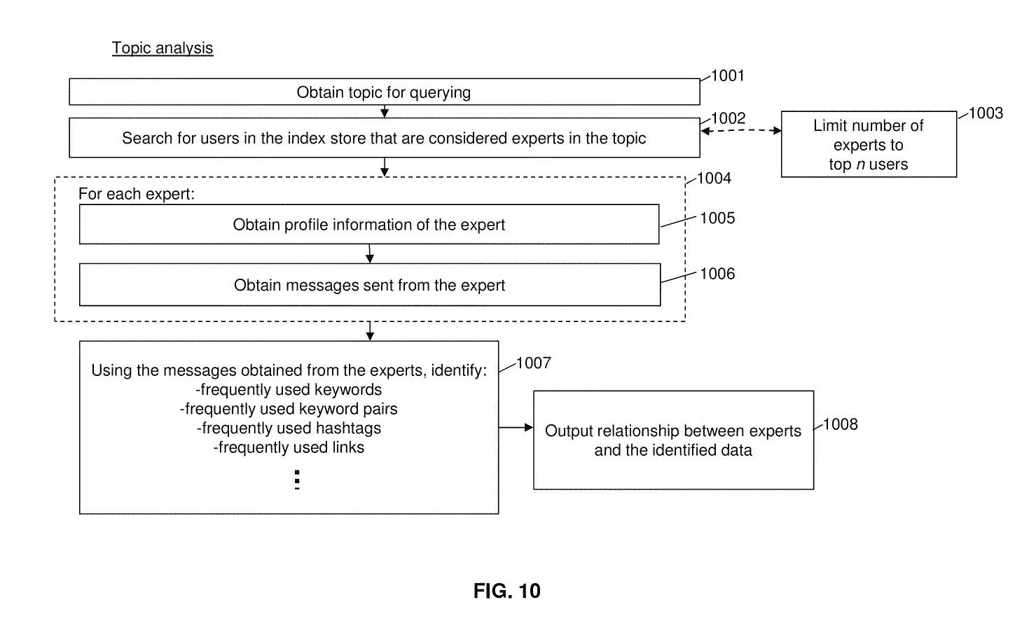

Turning to FIG. 10, an example embodiment of computer executable instructions are provided for topic analysis. At block 1001, the active receiver 103 obtains a topic for querying. At block 1002, the active receiver searches for users in the index store that are considered experts in the topic. The experts determined in block 1002 may be limited to the top n users (block 1003).

A set of instructions 1004 are executed for each expert identified in block 1002. In particular, the instructions include obtaining profile information of the expert (block 1005) and obtaining messages sent from the expert (block 1006).

Using the messages obtained from all the experts, the active receiver 103 identifies: frequently used keywords, frequently used keyword pairs, frequently used hashtags, frequently used links (e.g. URLs), etc. (block 1007). The active receiver then outputs the relationship between this information, including the profile information of the experts, and the given experts (block 1008). It will be appreciated that the keywords, keyword pairs, hashtags and links can be ordered from most frequently used to least frequently used. The top n most frequently results will be displayed on the GUI. The identification of the keywords, keyword pairs, etc. can be done using currently known or future known semantic processing, including removing stop words.

In an example embodiment, the extraction or search for experts in block 1002 can be identified using the Lucene index.

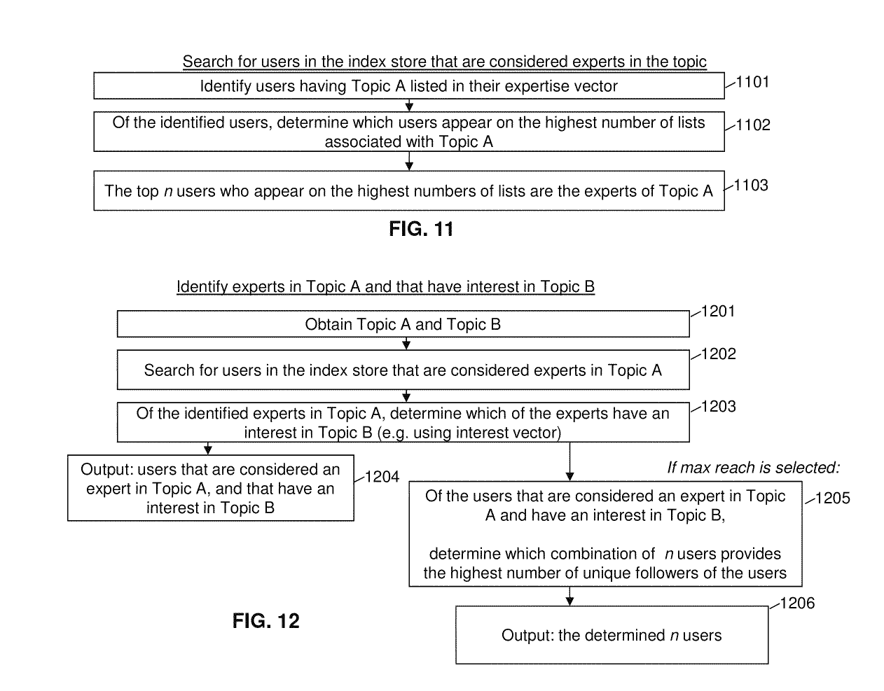

Turning to FIG. 11, example computer executable instructions are provided for implementing block 1002. At block 1101, the active receiver identifies users having Topic A (e.g. the topic being queried in FIG. 10) listed in their expertise vector. At block 1102, of the identified users, the active receiver determines which users appear on the highest number of lists associated with Topic A. At block 1103, the top n users who appear on the highest number of lists are the experts of Topic A.

Turning to FIGS. 12, 13 and 14, example embodiments of computer executable instructions for different queries are provided. These instructions may also be implemented by the relationships and correlations module 605, which is part of the active receiver 103.

The operations of FIG. 12 are used to identify experts in a given topic (e.g. Topic A) that have an interest in another topic (e.g. Topic B). At block 1201, the active receiver obtains Topic A and Topic B. At block 1202, the active receiver searches for users in the index store that are considered experts in Topic A. The operations presented with respect to FIG. 11 can be used, for example, to implement block 1202. Of the identified experts in Topic A, the active receiver determines which of the experts have an interest in Topic B (e.g. by analysing the interest vector of each identified expert) (block 1203). In particular, if the interest vector of an identified expert does include Topic B, then the identified expert is determined to have an interest in Topic B. If the interest vector of the identified expert does not include Topic B, then the identified expert does not have an interest in Topic B. In an example embodiment, the active receiver outputs the users that are considered an expert in Topic A and that have an interest in Topic B, as determined by block 1204.

In an alternative example embodiment, after block 1203 is executed, if the ‘max reach’ parameter has been selected (e.g. by the user), then the active receiver identifies users that are experts in Topic A, have an interest in B, and also maximize the number of unique followers of a predetermined number n of experts. The max reach operation 1205 includes, of the users that are considered an expert in Topic A and have an interest in Topic B, determining which combination of n users provides the highest number of unique followers of the users. The determined n users are outputted (block 1206). For example: Alice, Bob and Celine are identified from block 1203; the parameter n is 2; Alice has the followers David, Eve and Frank; Bob has the followers David and Eve; and Celine has the followers Gregory and Hanna. Based on this example, the combination of the experts Alice and Celine would provide the highest number of unique followers (e.g. five unique followers). By contrast, the combination of experts Alice and Bob would provide three unique followers.

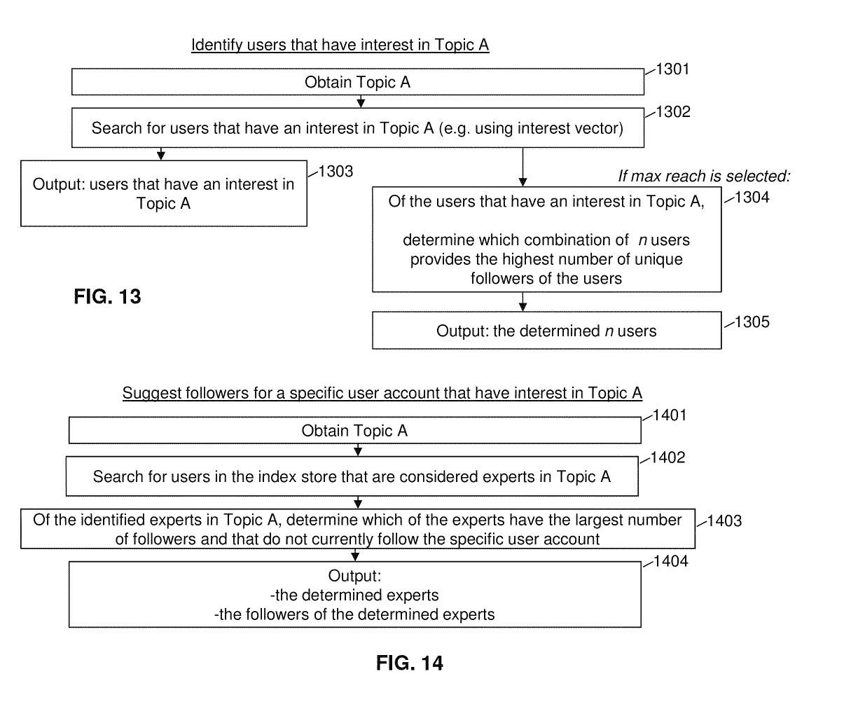

Turning to FIG. 13, the example computer executable instructions are for identifying users that have an interest in Topic A. At block 1301, the active receiver 100 obtains Topic A, for example, through a user input in the GUI. At block 1302, the active receiver searches for users that have an interest in Topic A (e.g. by analysing the index vector of each user). At block 1303, the identified users from block 1302 are outputted.

If the ‘max reach’ parameter has been selected, then in another example embodiment, of the users that have an interest in Topic A, the server determines which combination of n users provides the highest number of unique followers of the users (block 1304). The determined n users are outputted (block 1305).

Turning to FIG. 14, the example computer executable instructions are for suggesting followers for a specific user account that have an interest in Topic A. At block 1401, the active receiver obtains the Topic A. At block 1402, the active receiver searches for users in the index store that are considered experts in Topic A. At block 1403, of the identified experts for Topic A, the server determines which of the experts have the largest number of followers and that do not currently follow the specific user account. In an example embodiment, the server identifies the top n experts with the largest number of followers. At block 1404, the active receiver outputs the determined experts, or the followers of the determined experts, or both.

It will be appreciated that based on the users or experts, or both, identified in any of the queries described in FIGS. 12, 13 and 14, other data can be derived. For example, based on the users or experts, frequently used keywords, frequently used keyword pairs, frequently used hashtags, frequently used links, and profile information about the users and experts can be determined or obtained.

With respect to the influencer module 606, relationships related to influence are obtained. As used herein, the term “influencer” refers to a user account that primarily produces and shares content related to a topic and is considered to be influential to other users in the social data network.

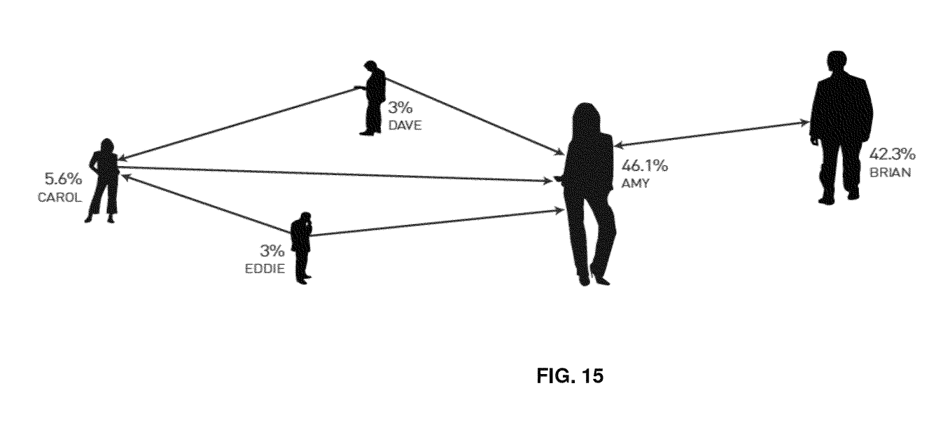

As an example, consider the simplified follower network for a particular topic in FIG. 15. Each user, actually a user account or a user name associated with a user account or user data address, is shown in relationship to the other users. The lines between the users, also called edges, represent relationships between the users. For example, an arrow pointing from the user account “Dave” to the user account “Carol” means Dave reads messages published by Carol. In other words, Dave follows Carol. A bi-directional arrow between Amy and Brian means, for example, Amy follows Dave and Dave follows Amy. Beside each user account in FIG. 15, a PageRank score is provided. The PageRank algorithm is a known algorithm used by Google to measure the importance of website pages in a network and can be also applied to measuring the importance of users in a social data network.

Continuing with FIG. 15, Amy has the greatest number of followers (i.e. Dave, Carol, and Eddie) and is the most influential user in this network (i.e. PageRank score of 46.1%). However, Brian, with only one follower (i.e. Amy), is more influential than Carol with two followers (i.e. Eddie and Dave), primarily because Brian has a significant portion of Amy's mindshare. In other words, using the proposed systems and methods herein, although Carol has more followers than Brian, she does not necessarily have a greater influence than Brian. Hence, using the proposed systems and methods described herein, the number of followers of a user is not the sole determination for influence. In an example embodiment, identifying who are the followers of a user may also be factored into the computation of influence.

The example network in FIG. 15 is represented in Table 1, and it illustrates how PageRank can significantly differ from the number of followers.

TABLE 1
Twitter follower counts and PageRank scores
for sample network represented in FIG. 1.

| User Handle | Follower Count | PageRank |
|---|---|---|
| Amy | 4 | 46.1% |
| Brian | 1 | 42.3% |
| Carol | 2 | 5.6% |
| Dave | 0 | 3.0% |
| Eddie | 0 | 3.0% |

Amy is clearly the top influencer with the greatest number of followers and highest PageRank score. Although Carol has two followers, she has a lower PageRank metric than Brian who has one follower. However, Brian's one follower is the most-influential Amy (with four followers), while Carol's two followers are low influencers with (0 followers each). The intuition is that, if a few experts consider someone an expert, then s/he is also an expert. However, the PageRank algorithm gives a better measure of influence than only counting the number of followers. As will be described below, the PageRank algorithm and other similar ranking algorithms can be used with the proposed systems and methods described herein.

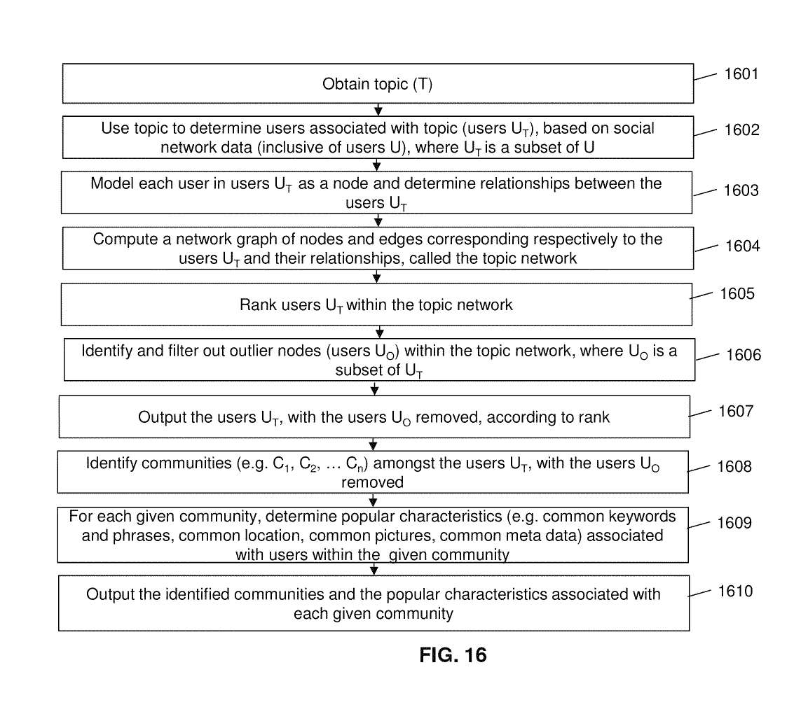

Turning to FIG. 16, an example embodiment of computer executable instructions are shown for determining one or more influencers of a given topic. The social network data, or social data, includes multiple users that are represented as a set U. At block 1601, the active receiver 103 obtains a topic represented as T. At block 1602, the active receiver uses the topic to determine users from the social network data which are associated with the topic. This determination can be implemented in various ways and will be discussed in further detail below. The set of users associated with the topic is represented as U_{T}, where U_{T} is a subset of U.

Continuing with FIG. 16, the active receiver module models each user in the set of users U_{T} as a node and determines the relationships between the users U_{T} (block 1603). The active receiver computes a network of nodes and edges corresponding respectively to the users U_{T} and the relationships between the users U_{T} (block 1604). In other words, the active receiver creates a network graph of nodes and edges corresponding respectively to the users U_{T} and their relationships. The network graph is called the “topic network”. It can be appreciated that the principles of graph theory are applied here. The relationships that define the edges or connectedness between two entities or users U_{T} can include for example: friend connection and/or follower-followee connection between the two entities within a particular social networking platform. In an additional aspect, the relationships could include other types of relationships defining social media connectedness between two entities such as: friend of a friend connection. In yet another aspect, the relationship could include connectedness of a friend or follower connection across different social network platforms (e.g. Instagram and Facebook). In yet a further aspect, the relationship between the users U_{T} as defined by the edges can include for example: users connected via re-posts of messages by one user as originally posted by another user (e.g. re-tweets on Twitter), and/or users connected through replies to messages posted by one user and commented by another user via the social networking platform. Referring again to FIG. 16, the presence of an edge between two entities indicates the presence of at least one type of relationship or connectedness (e.g. friend or follower connectivity between two users) in one or more social networking platforms.

The active receiver then ranks users within the topic network (block 1605). For example, the server uses PageRank to measure importance of a user within the topic network and to rank the user based on the measure. Other non-limiting examples of ranking algorithms that can be used include: Eigenvector Centrality, Weighted Degree, Betweenness, Hub and Authority metrics.

The active receiver identifies and filters out outlier nodes within the topic network (block 1606). The outlier nodes are outlier users that are considered to be separate from a larger population or clusters of users in the topic network. The set of outlier users or nodes within the topic network is represented by U_{O}, where U_{O} is a subset of U_{T}. Further details about identifying and filtering the outlier nodes are described below.

At block 1607, the active receiver outputs the users U_{T}, with the users U_{O} removed, according to rank.

In an alternate example embodiment, block 1606 is performed before block 1605.

At block 1608, the active receiver identifies communities (e.g. C₁, C₂, . . . , Cₙ) amongst the users U_{T} with the users U_{O} removed. The identification of the communities can depend on the degree of connectedness between nodes within one community as compared to nodes within another community. That is, a community is defined by entities or nodes having a higher degree of connectedness internally (e.g. with respect to other nodes in the same community) than with respect to entities external to the defined community. In an example embodiment, the value or threshold for the degree of connectedness used to separate one community from another can be pre-defined. The resolution thus defines the density of the interconnectedness of the nodes within a community. Each identified community graph is thus a subset of the network graph of nodes and edges (the topic network) defined in block 1604 for each community. In one aspect, the community graph further provides both a visual representation of the users in the community (e.g. as nodes) with the community graph and a textual listing of the users in the community. In yet a further aspect, the listing of users in the community is ranked according to degree of influence within the community and/or within all communities for topic T In accordance with block 1608, users U_{T} are then split up into their community graph classifications such as U_{C1}, U_{C2}, . . . U_{Cn}.

At block 1609, for each given community (e.g. C₁), the active receiver determines popular characteristic values for pre-defined characteristics (e.g. one or more of: common words and phrases, topics of conversations, common locations, common pictures, common meta data) associated with users (e.g. U_{C1}) within the given community based on their social network data. The selected characteristic (e.g. topic or location) can be user-defined and/or automatically generated (e.g. based on characteristics for other communities within the same topic network, or based on previously used characteristics for the same topic T). At block 1610, the active receiver outputs the identified communities (e.g. C₁, C₂, . . . , Cₙ) and the popular characteristics associated with each given community.

It is appreciated that blocks 1608, 1609 and 1610 are optional and are related to further identifying communities and characteristics associated with the influencers outputted at block 1607.

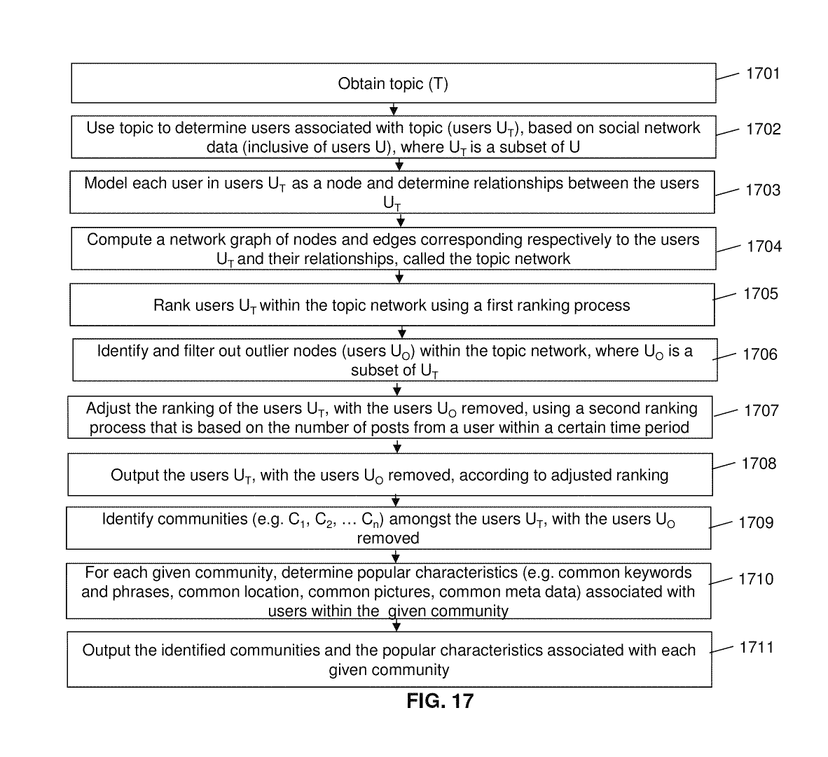

Turning to FIG. 17, another example embodiment of computer executable instructions are shown for determining one or more influencers of a given topic. Blocks 1701 to 1704 correspond to blocks 1601 to 1604. Following block 1704, the active receiver ranks users within the topic network using a first ranking process (block 1705). The first ranking process may or may not be the same ranking process used in block 1605. The ranking is done to identify which users are the most influential in the given topic network for the given topic.

At block 1706, the active receiver identifies and filters out outlier nodes (users U_{O}) within the topic network, where U_{O} is a subset of U_{T}. At block 1707, the active receiver adjusts the ranking of the users U_{T}, with the users U_{O} removed, using a second ranking process that is based on the number of posts from a user within a certain time period. For example, the active receiver determines that if a first user has a higher number of posts within the last two months compared to the number of posts of a second user within the same time period, then the first user's original ranking (from block 1705) may be increased, while the second user's ranking remains the same or is decreased. At block 1708, the active receiver outputs the users U_{T}, with the users U_{O} removed, according to rank.

It is recognized that a network graph based on all the users U may be very large. For example, there may be hundreds of millions of users in the set U. Analysing the entire data set related to U may be computationally expensive and time consuming. Therefore, using the above process to find a smaller set of users U_{T} that relate to the topic T reduces the amount of data to be analysed. This decreases the processing time as well. In an example embodiment, near real time results of influencers have been produced when analysing the entire social network platform of Twitter. Using the smaller set of users U_{T} and the data associated with the user U_{T}, a new topic network is computed. The topic network is smaller (i.e. less nodes and less edges) than the social network graph that is inclusive of all users U. Ranking users based on the topic network is much faster than ranking users based on the social network graph inclusive of all users U.

Furthermore, identifying and filtering outlier nodes in the topic network helps to further improve the quality of the results.

At block 1709, the active receiver is configured to identify communities (e.g. C₁, C₂, . . . , Cₙ) amongst the users U_{T} with the users U_{O} removed in a similar manner as previously described in relation to block 1608. At block 1710, the active receiver is configured to determine, for each given community (e.g. C₁), popular characteristic values for pre-defined characteristics (e.g. common keywords and phrases, topics of conversations, common locations, common pictures, common meta data) associated with users (e.g. U_{C1}) within the given community (e.g. C₁), based on their social network data in a similar manner as previously described in relation to block 1609. At block 1711, the server is configured to output the identified communities and the characteristic values for the popular characteristics associated with each given community (e.g. C₁-Cₙ) in a similar manner as block 1610.

It is recognized that the data from the topic network can be improved by removing problematic outliers. For instance, a query using the topic “McCafe” referring to the McDonalds coffee brand also happened to bring back some users from the Philippines who are fans of a karaoke bar/cafe of the same name. Because they happen to be a tight-knit community, their influencer score is often high enough to rank in the critical top-ten list.

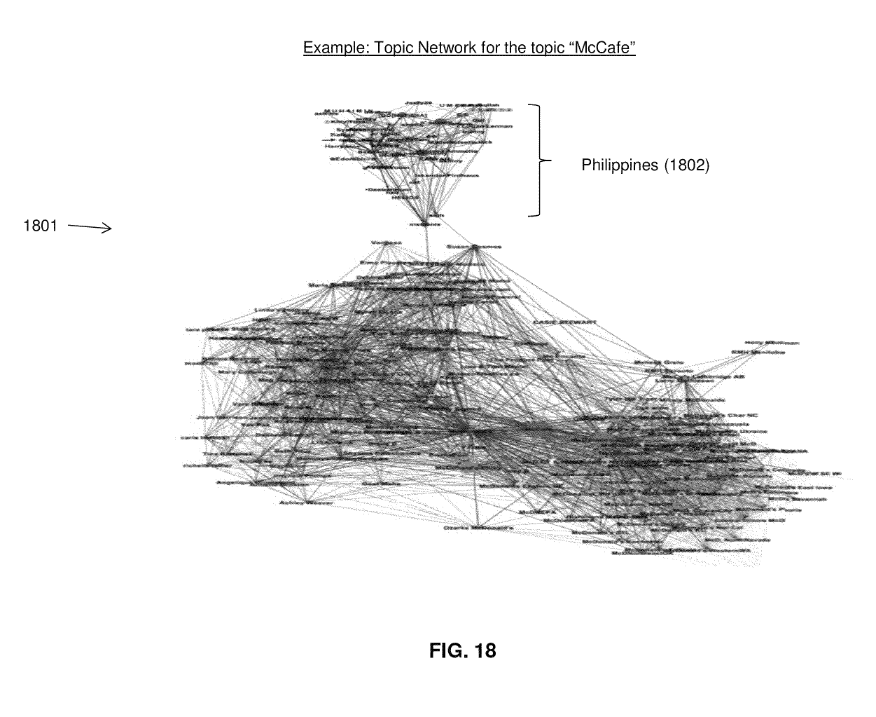

Turning to FIG. 18, an illustration of an example embodiment of a topic network 1801 showing unfiltered results is shown. The nodes represent the set of users U_{T} related to the topic McCafe. Some of the nodes 1802 or users are from the Philippines who are fans of a karaoke bar/cafe of the same name McCafe.

This phenomenon sometimes occurs in test cases, not limited to the test case of the topic McCafe. It is herein recognized that a user who looks for McCafe is not looking for both the McDonalds coffee and the Filipino karaoke bar, and thus this sub-network 1802 is considered noise.

To accomplish noise reduction, in an example embodiment, the server uses a network community detection algorithm called Modularity to identify and filter these types of outlier clusters in the topic queries. The Modularity algorithm is described in the article cited as Newman, M. E. J. (2006) “Modularity and community structure in networks,” PROCEEDINGS-NATIONAL ACADEMY OF SCIENCES USA 103 (23): 8577-8696, the entire contents of which are herein incorporated by reference.

It will be appreciated that other types of clustering and community detection algorithms can be used to determine outliers in the topic network. The filtering helps to remove results that are unintended or sought after by a user looking for influencers associated with a topic.

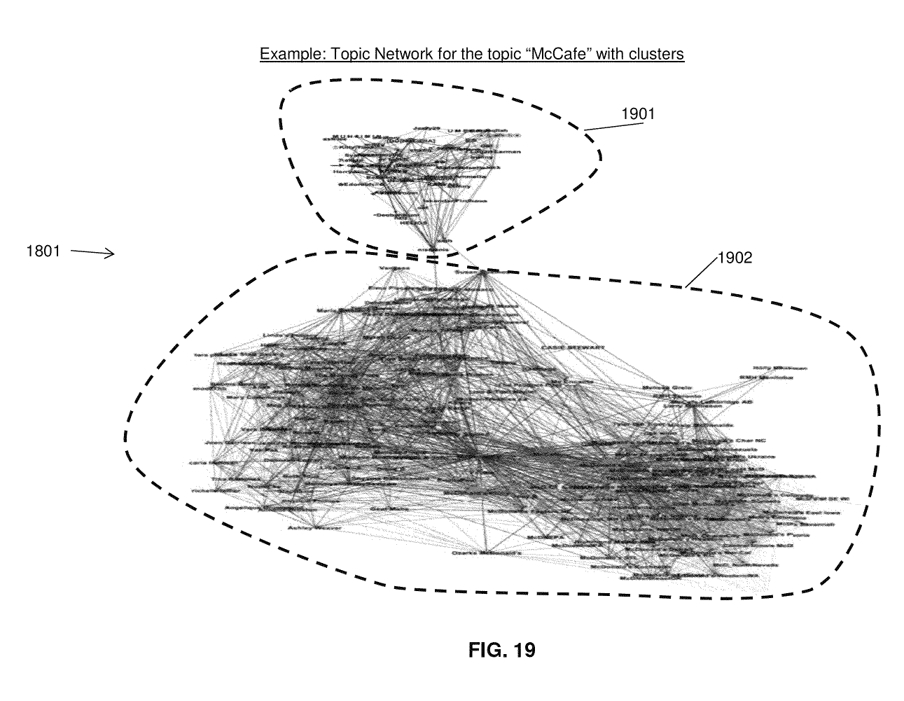

As shown in FIG. 19, an outlier cluster 1901 is identified relative to a main cluster 1902 in the topic network 1801. The outlier cluster of users U_{O} 1901 is removed from the topic network, and the remaining users in the main cluster 1902 are used to form the ranked list of outputted influencers.

In an example embodiment, the active receiver 103 computes the following instructions to filter out the outliers:

1. Execute the Modularity algorithm on the topic network.

2. The Modularity function decomposes the topic network into modular communities or sub-networks, and labels each node into one of X clusters/communities. In an example embodiment, X<N/2, as a community has more than one member, and N is the number of users in the set U_{T}.

3. Sort the communities by the number of users within a community, and accept the communities with the largest populations.

4. When the cumulative sum of the node population exceeds 80% of the total, remove the remaining smallest communities from the topic network.

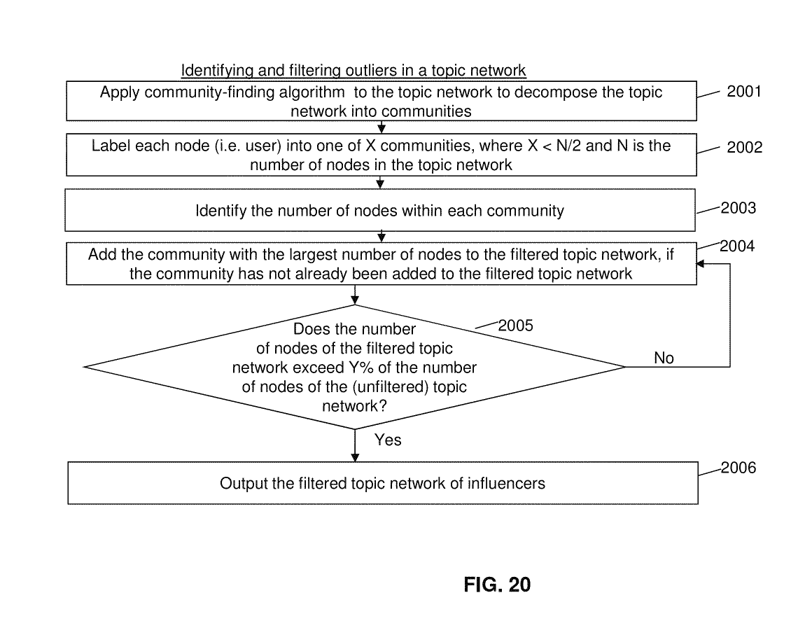

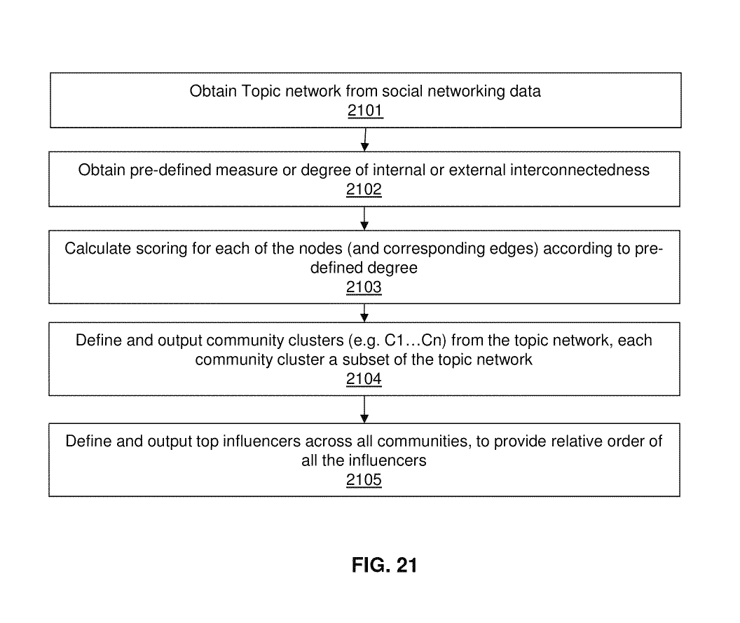

A general example embodiment of the computer executable instructions for identifying and filtering the topic network is described with respect to FIG. 20. It can be appreciated that these instructions can be used to execute blocks 1606 and 1706.

At block 2001, the active receiver applies a community-finding algorithm to the topic network to decompose the network into communities. Non-limiting examples of algorithms for finding communities include the Minimum-cut method, Hierarchical clustering, the Girvan-Newman algorithm, the Modularity algorithm referenced above, and Clique-based methods.

At block 2002, the active receiver labels each node (i.e. user) into one of X communities, where X<N/2 and N is the number of nodes in the topic network.

At block 2003, the active receiver identifies the number of nodes within each community.

The active receiver then adds the community with the largest number of nodes to the filtered topic network, if that community has not already been added to the filtered topic network (block 2004). It can be appreciated that initially, the filtered topic network includes zero communities, and the first community added to the filtered topic network is the largest community. The same community from the unfiltered topic network cannot be added more than once to filtered topic network.

At block 2005, the active receiver determines if the number of nodes of the filtered topic network exceeds, or is greater than, Y % of the number of nodes of the original or unfiltered topic network. In an example embodiment, Y % is 80%. Other percentage values for Y are also applicable. If not, then the process loops back to block 1504. When the condition of block 1505 is true, the process proceeds to block 1506.

Generally, when the number of nodes in the filtered topic network reaches or exceeds a majority percentage of the total number of nodes in the unfiltered topic network, then the main cluster has been identified and the remaining nodes, which are the outlier nodes (e.g. U_{O}), are also identified.

At block 2006, the filtered topic network is outputted, which does not include the outlier user U_{O}.

Turning to FIG. 21, an example embodiment of computer executable instructions are shown for identifying and outputting communities from social network data, which can be performed by the influencer module 606, or more generally the active receiver 103.

A feature of social network platforms is that users are following (or defining as a friend) another user. As described earlier, other types of relationships or interconnectedness can exist between users as illustrated by a plurality of nodes and edges within a topic network. Within the topic network, influencers can affect different clusters of users to varying degrees. That is, based on the process for identifying communities as described in relation to FIG. 21, the active receiver is configured to identify a plurality of clusters within a single topic network, referred to as communities. Since influence is not uniform across a social network platform, the community identification process defined in relation to FIG. 21 is advantageous as it identifies the degree or depth of influence of each influencer (e.g. by associating with one community over another) across the topic network.

As will be defined in FIG. 21, the active receiver is configured to provide a set of distinct communities (e.g. C1, . . . , Cn), and the top influencer(s) in each of the communities. In yet a preferred aspect, the active receiver is configured to provide an aggregated list of the top influencers across all communities to provide the relative order of all the influencers.

At block 2101, the active receiver is configured to obtain topic network graph information from social networking data as described earlier (e.g. FIG. 16 and FIG. 17). The topic network visually illustrates relationships among the nodes a set of users (U_{T}) each represented as a node in the topic network graph and connected by edges to indicate a relationship (e.g. friend or follower-followee, or other social media interconnectivity) between two users within the topic network graph. At block 2102, the active receiver obtains a pre-defined degree or measure of internal and/or external interconnectedness (e.g. resolution) for use in defining the boundary between communities.

At block 2103, the active receiver is configured to calculate scoring for each of the nodes (e.g. influencers) and edges according to the pre-defined degree of interconnectedness (e.g. resolution). That is, in one example, each user handle is assigned a Modularity class identifier (Mod ID) and a PageRank score (defining a degree of influence). In one aspect, the resolution parameter is configured to control the density and the number of communities identified. In a preferred aspect, a default resolution value of 2 which provides 2 to 10 communities is utilized by the active receiver. In yet another aspect, the resolution value is user defined to generate higher or lower granularity of communities as desired for visualization of the community information.

At block 2104, the active receiver is configured to define and output distinct community clusters (e.g. C₁, C₂, . . . , Cₙ) thereby partitioning the users U_{T} into U_{C1} U_{Cn} such that each user defined by a node in the network is mapped to a respective community. In one aspect, modularity analysis is used to define the communities such that each community has dense connections (high connectivity) between the cluster of nodes within the community but sparse connections with nodes in different communities (low connectivity). In one aspect, the community detection process steps 2103-2106 can be implemented utilizing a modularity algorithm and/or a density algorithm (which measures internal connectivity).

At block 2105, the active receiver is configured to define and output top influencer across all communities and/or top influencers within each community and provide relative ordering of all influencers. In yet a further aspect, at block 2105, the active receiver is configured to output an aggregated list of all the top influencers across all communities to provide the relative order of all the influencers.

In another aspect of the influencer module 606, an influencer and the influencer's community are determined using weighted edges or connections between users or followers in the social network. In context of a topic, an influencer is an individual or entity represented in the social data network that: is considered to be interested in the topic or generate content about the topic; has a large number of followers (e.g. or readers, friends or subscribers), a significant percent of which are interested in the topic; and has a significant percentage of the topic-interested followers that value the influencer's opinion about the topic. Non-limiting examples of a topic include a brand, a company, a product, an event, a location, and a person.

Continuing with the example of using weighted edges or connections, several types of edges or connections are considered between different user nodes (e.g. user accounts) in a social data network. These types of edges or connections include: (a) a follower relationship in which a user follows another user; (b) a re-post relationship in which a user re-sends or re-posts the same content from another user; (c) a reply relationship in which a user replies to content posted or sent by another user; and (d) a mention relationship in which a user mentions another user in a posting.

In the example of using weighted edges to identify top influencers and their communities, the network links are weighted to create a notion of link importance and further, external sources are identified and incorporated into the social data network. Examples of external sources include users and their activities of re-posting an old message or content posting, or users and their activities of referencing or mention an old message or content posting. Another example of an external source is a user and their activity of mentioning a topic in a social data network, but the topic originates from another or ancillary social data network.

Below are example computer executable or processor implemented instructions for generating a weighted influencer graph, which may be used in combination with the other operations of the influencer module 606.

1. Obtain a topic represented as T. For example, the topic is obtained from one of the other modules or from a process performed by the active receiver module.

2. The active receiver module uses the topic to identify all posts related to the topic. These set of posts are collectively denoted as P_{T}. In an example embodiment, one or more additional search criteria are used, such as a specified time period. In other words, the server may only be examining posts related to the topic within a given period of time.

3. The active receiver module obtains authors of the posts P_{T} and identifies the top N authors based on rank. The set of top ranked authors is represented by A_{T}. In an example embodiment, the top N authors are identified using the Authority Score. Other methods and processes may be used to rank the authors. For example, the server uses PageRank to measure importance of a user within the topic network and to rank the user based on the measure. Other non-limiting examples of ranking algorithms that can be used include: Eigenvector Centrality, Weighted Degree, Betweenness, Hub and Authority metrics. It is appreciated that the authors are uses in the social network that authored the posts. It is also appreciated that N is a counting number. Non-limiting example values of N include those values in the range of 3,000 to 5,000. Other values of N can be used.

4. The active receiver module characterizes each of the posts P_{T} as a ‘Reply’, a ‘Mention’, or a ‘Re-Post’, and respectively identifies the user being replied to, the user being mentioned, and the user who originated the content that was re-posted (e.g. grouped as replied to users U_{R}, mentioned users U_{M}, and re-posted content from users U_{RP}). The time stamp of each reply, mention, re-post, etc. may also be recorded in order to determine whether an interaction between users is recent, or to determine a ‘recent’ grading.

5. The active receiver module generates a list called ‘users of interest’ that combines the top N authors A_{T} and the users U_{R}, U_{M}, and U_{RP}. Non-limiting examples of the numbers of users in the ‘users of interest’ list or group include those numbers in range of 3,000 to 10,000. It will be appreciated that the number of users in the ‘users of interest’ group or list may be other values.

6. For each user in the ‘users of interest’ list, the active receiver module identifies or obtains the followers of each user.

7. The active receiver module removes the followers that are not listed in the ‘users of interest’ list, while still having identified the follower relationships between those users that are part of the ‘users of interest’. In a non-limiting example implementation of step 6, it was found that there were several million follower connections or edges when considering all the followers associated with the ‘users of interest’. Considering all of these follower edges may be computationally consuming and may not reveal influential interactions. To reduce the number of follower edges, those followers that are not part of the ‘users of interest’ are discarded as per step 7.

In an alternative embodiment of steps 6 and 7, the active receiver module identifies the follower relationships limited to only users listed in the ‘users of interest’ group.

8. The active receiver module creates a link between each user in the ‘users of interest’ list and its followers. This creates the follower-following network where all the links have the same weight (e.g., weight of 1.0).

9. Between each user pair (e.g. A, B) in the ‘users of interest’ list, the active receiver module identifies the number of instances A mentions B, the number of instances A replies to B, and the number of instances A re-posts content from B. It can be appreciated that a user pair does not have to have a follower-followee relationship. For example, a user A may not follow a user B, but a user A may mention user B, or may re-post content from user B, or may reply to a posting from user B. Thus, there may be an edge or link between a user pair (A,B), even if one is not a follower of the other.

10. Between each user pair (e.g. A, B), the active receiver module computes a weight associated with the link or edge between the pair A, B, where the weight is a function of at least the number of instances A mentions B, the number of instances A replies to B, and the number of instances A re-posts content from B. For example, the higher the number of instances, the higher the weighting.

In an example embodiment, at block 308, the weighting of an edge is initialized at a first value (e.g. value of 1.0) when there is a follower-followee link and otherwise the edge is initialized at a second value (e.g. value of 0) where there is no follower-followee link, where the second value is less than the first value. Each additional activity (e.g. reply, repost, mention) between two users will increase the edge weight to a maximum weighting value of 4.0. Other numbers or ranges can be used to represent the weighting.

In an example embodiment, the relationship between the increasing number of activity or instances and the increasing weighting is characterized by an exponentially declining scale. For example, consider a user pair A,B, where A follows B. If there are 2 re-posts, the weighting is 2.0. If there are 20 re-posts, the weighting is 3.9. If there are 400 re-posts, the weighting is 4.0. It is appreciated that these numbers are just for example and that different numbers and ranges can be used.

In an example embodiment, the weighting is also based on how recent did the interaction (e.g. the re-post, the mention, the reply, etc.) take place. The ‘recent’ grading may be computed by determining the difference in time between the date the query is run and the date that an interaction occurred. If the interactions took place more recently, the weighting is higher, for example.

11. The active receiver module computes a network graph of nodes and edges corresponding respectively to the users of the ‘users of interest’ list and their relationships, where the relationships or edges are weighted (e.g. also called the topic network). It can be appreciated that the principles of graph theory are applied here. The relationships defined at step 11 may be outputted by the active receiver module, or further processing is performed to identify communities (e.g. steps 12-14), or both.

12. The active receiver module identifies communities (e.g. C₁, C₂, . . . , Cₙ) amongst the users in the topic network. The identification of the communities can depend on the degree of connectedness between nodes within one community as compared to nodes within another community. That is, a community is defined by entities or nodes having a higher degree of connectedness internally (e.g. with respect to other nodes in the same community) than with respect to entities external to the defined community. As will be defined, the value or threshold for the degree of connectedness used to separate one community from another can be pre-defined. The resolution thus defines the density of the interconnectedness of the nodes within a community. Each identified community graph is thus a subset of the network graph of nodes and edges (the topic network) for each community. In one aspect, the community graph further displays both a visual representation of the users in the community (e.g. as nodes) with the community graph and a textual listing of the users in the community. In yet a further aspect, the display of the listing of users in the community is ranked according to degree of influence within the community and/or within all communities for topic T. In accordance with step 12, users U_{T} are then split up into their community graph classifications such as U_{C1}, U_{C2}, . . . U_{Cn}.

13. For each given community (e.g. C₁), the active receiver module determines popular characteristic values for pre-defined characteristics (e.g. one or more of: common words and phrases, topics of conversations, common locations, common pictures, common meta data) associated with users (e.g. U_{O1}) within the given community based on their social network data. The selected characteristic (e.g. topic or location) can be user-defined and/or automatically generated (e.g. based on characteristics for other communities within the same topic network, or based on previously used characteristics for the same topic T).

14. The active receiver module server outputs the identified communities (e.g. C₁, C₂, . . . , Cₙ) and the popular characteristics associated with each given community. The identified communities may be output as a community graph in association with the characteristic values for a pre-defined characteristic for each community.

Using the weighted edges or connections, influencers may be more accurately identified as well as each influencer's score (e.g. weighted PageRank score). Accordingly, a relationship between an influencer and other users in their community, a relationship between an influencer and a topic, or a relationship between users in an influencer's community and a topic, may be identified and more accurately characterized by the active receiver module.

With respect to the behavioral segmentation module 607, the active receiver 103 is configured to track user segmentation and behaviours. As used herein, the term “user segmentation” can refer to for example dividing a target market data into subsets of consumers, called segments that have common attributes or needs. In general, behavioural segmentation as used herein refers to a computer-implemented method and system for dynamically tracking and grouping consumers and/or users based on specific behavioural patterns and activities they display when interacting with social networking platforms (e.g. via content of social media conversations, “tweets” and/or posts and/or comments and/or chat sessions) such as social networking websites.

The proposed systems and methods, as described herein, dynamically determine and calculate user behaviour segmentation patterns associated with user activity in relation to social networking platforms. This information can subsequently be useful for designing and implementing strategies to target specific needs of individual “segments”.

More generally, the proposed systems and methods provide a computer-implemented method and system to determine and analyze user behaviours (e.g. in relation to particular common topic of conversation or “tweet” associated with a social networking platform) for a number of users for the social networking platform. The system and method further includes determining other overlapping or commonality in the behaviour patterns of the users (e.g. for those users that shared a common topic or conversation). The result providing an analysis of user segmentation patterns relating to social networking activity (e.g. posts).

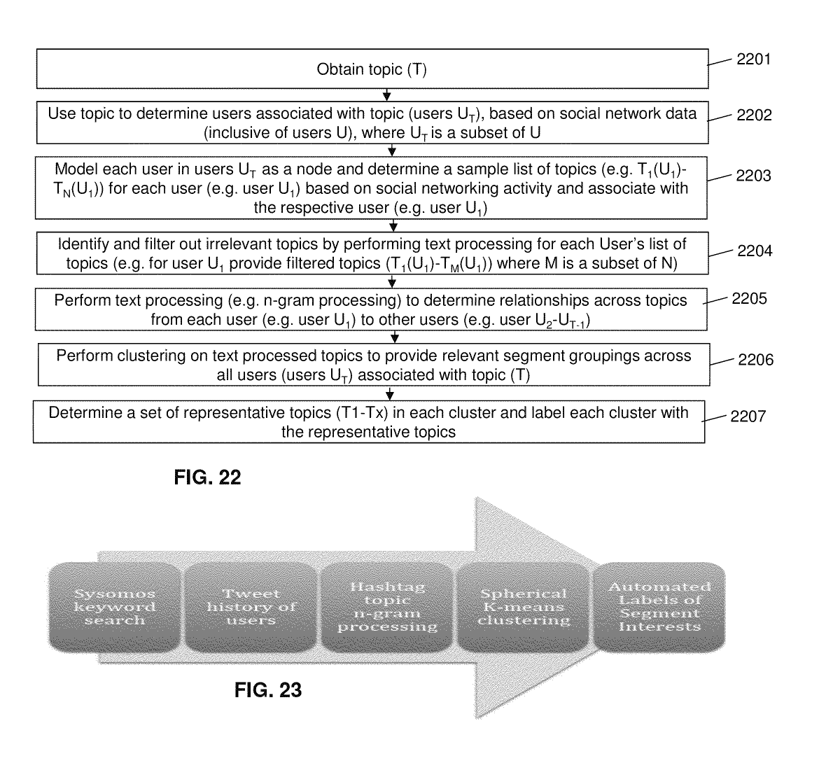

Turning to FIG. 22, an example embodiment of computer executable instructions are provided for determining one or more dynamical behavioural segments for a plurality of social networking users based on a particular topic of interest, topic T. The process shown in FIG. 22 may be implemented by the behavioral segmentation module 607, or more generally the active receiver 103. It will be understood that the social network data includes multiple users that are represented as a set U. At block 2201, the active receiver obtains a topic represented as T. At block 2202, the active receiver uses the topic to determine users from the social network data which are associated with the topic. This determination can be implemented in various ways and will be discussed in further detail below. The set of users associated with the topic is represented as U_{T}, where U_{T} is a subset of U.

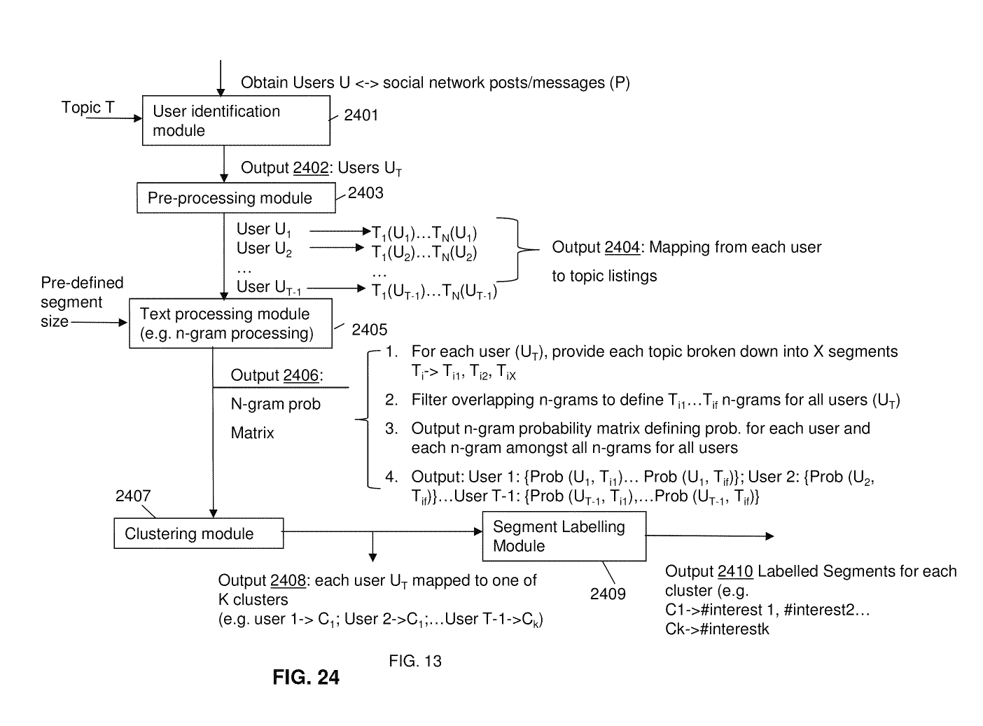

Continuing with FIG. 22, at block 2203, the active receiver models each user in the set of users U_{T} as a node and determines a sample list of topics (e.g. T₁(U₁)−T_{N}(U₁)))) for each user (e.g. user U₁) based on social networking activity and associate with the respective user (e.g. user U₁). As will be described in relation to FIG. 23, in one example this involves collecting a sample of social networking posts (e.g. Tweets for Twitter users) having a pre-defined sample size (e.g. a pre-defined number of recent or randomly selected posts and/or posts during a specific time duration). At block 2204, the active receiver identifies and filters out irrelevant topics by performing text processing for each User's list of topics (e.g. for user U₁ provide filtered topics (T₁(U₁)−T_{M}(U₁)) where M is a subset of N). As discussed in relation ti FIG. 23, in one example this step includes extracting text from posts (e.g. tweets, comments, chats and other social networking posts) to determine a listing of topics for all users U_{T} and normalizing the extracted text while filtering out topics that are pre-determined to be irrelevant. This step further comprises relationship mapping between each textual topics (e.g. hashtags) and the corresponding user that posted the topic.

The computer executable instructions of block 2203 and 2204 are implemented by the pre-processing module 129.

Referring again to FIG. 22, at block 2205, the active receiver performs text processing (e.g. n-gram processing) to determine relationships across topics from each user (e.g. user U₁) to other users (e.g. user U₂-U_{T-1}). The relationships depict the statistical overlap amongst users for each topic (or stems of the topics as provided by breaking down the topic into n-grams) as shown in the exemplary chart below.

| | Tri-gram word stems from the list of topics for all users | | | | |
|---|---|---|---|---|---|
| | U_{T}: (T₁(U₁₋U_{T-1}) − T_{N}(U₁₋U_{T-1})) | | | | |
| Users | “iph” | “pho” | “hon” | “one” | “the” |

| | | | | |
|---|---|---|---|---|
| A | 0.2 | 0.2 | 0.2 | 0.2 |
| B | 0.3 | 0.3 | 0.3 | 0.3 |

In the case of n-gram processing, the result is a chart where one dimension shows the users (e.g. U1, U2), another dimension shows each topic broken down into n-grams (e.g. “iph”, “pho”, “hon”, “one”, “the”) for each user and each cell value represents the TF-IDF statistic.

Generally speaking, the tf-idf statistical value is the term frequency inverse document frequency which is a numerical statistic and provides information on the importance of each broken down segment of the topic words (e.g. a topic broken down into its n-gram) for each topic amongst the various broken down segments of topics for a user. That is, the tf-idf for a segment of a topic word (e.g. “iph”) reflects the statistic value based on the number of times the segment (e.g. “iph”) appears in the listing of all topics for the user. That is, for user1, the segmented topic (e.g. “iph”) may have a statistical probability of X among all topics (e.g. topics T₁(U₁)−T_{M}(U₁) as shown in FIG. 22) for the particular user, user1. The n-grams TF-IDF provide a statistical likelihood of the occurrence of the n-gram for the particular user. Accordingly, for each user, a listing of TF-IDF is output associated with respective n-grams. The vector of n-gram tf-idf's are thus fed into the clustering module at block 2206.

At block 2206, the active receiver performs clustering on text processed topics (e.g. receiving a vector of TF-IDF values for each n-gram of a respective user) to provide relevant segment groupings across all users (users U_{T}) associated with a topic.

At block 2207, the active receiver determines a set of representative topics (T1-Tx) in each cluster and label each cluster with the representative topics.

In one embodiment, not illustrated in FIG. 22, subsequent to the step illustrated at block 2205, the active receiver identifies and filters out outlier nodes within the topic network. This can be done, for example, using n-gram processing. The outlier nodes are outlier users that are considered to be separate from a larger population or clusters of users in the topic network. That is, they can relate to users that have a topic without a sufficient measure of commonality with topics of other users (e.g. as determined by the n-gram processing, the subsets of a particular topic for a user does not statistically overlap over a pre-defined threshold with the subsets of each topic for other users. The set of outlier users or nodes within the topic network is represented by UO, where UO is a subset of UT. In one aspect, the users UT are outputted, with the users UO removed.

Referring to FIG. 23, an example implementation of the blocks 2201-2207 in FIG. 22 for performing dynamic segmentation of data relating specifically to Twitter users. The segmentation method, an example of which is depicted in FIG. 23, thus uses these exemplary steps:

1. Gather list of users for a particular query or topic. This list can be compiled, for example, by gathering all users who have tweeted about a given search term query (e.g. Tweets from users who have used “iPhone” in their tweets, in the past 6 months), or simply all followers of a specific brand handle.

2. For each user, gather a random sample listing of their tweet history (e.g. posts related to a specific social networking platform Twitter). In one aspect, the sample will be taken from their recent tweets to get an accurate picture of their current interests and preferences. In a preferred aspect, a sample size between 500 to 1000 tweets is preferred to extract enough hashtags to be useful.

3. Extract the hashtags from each of the user's historical tweets, and associate each one to the corresponding user. The result should be a map from user to a list of hashtags.

4. Perform text processing on each user's list of hashtags, normalizing the text to lowercase, and removing common hashtags that convey no meaning such as “#RT” (i.e. stopword removal).

5. From the full list of hashtags, use a character n-gram model to represent the hashtags using term-frequency inverse document frequency (TF-IDF). The result of this process is a document-term matrix where the columns represent the users, the row represents the n-grams, and each cell represents the TF-IDF statistic.

In a preferred aspect, a trigram (n=3) model for n-gram processing results in an optimal balance between processing speed and segmentation quality.

6. Using an unsupervised machine learning clustering method for a pre-defined number of clusters e.g. in one aspect k=[5, 9] gives highly relevant segments. In a preferred aspect, spherical k-means clustering algorithm is particularly effective in clustering high dimensional text data. The final result of this algorithm is a mapping from each user to one of the k clusters.

However, one of the aspects of a clustering analysis is the labeling of the clusters. To address this issue, an additional step is added to label the clusters: 1. For each cluster, collect all the hashtags associated with each user in that cluster. 2. For each hashtag, count the number of users who have used that hashtag in that cluster. 3. Label that cluster with the top hashtags for each cluster. In a preferred embodiment, the top ten or so hashtags provides a good labeling of the cluster.

Referring to FIG. 23, the end result provided by the steps according to the present example is a set of k segments, which are labeled with a set of hashtags denoting the interests of the users in the segment. In a preferred aspect, this type of behavioural segmentation is very powerful for marketers and CRM applications.

Turning to FIG. 24, shown is a flow diagram of an example embodiment of computer executable instructions associated with different modules including: a computer-implemented user identification module 2401, a pre-processing module 2403, a text processing module 2405, a clustering module 2407, and a segment labelling module 2409. These modules are part of the behavioural segmentation module 607. As illustrated, the user identification module 2401 obtains data relating to a plurality of users U and their associated social networking posts/messages (e.g. Tweets). The user identification module 2401 then extracts a listing of users U_{T} that have social networking posts/messages relating to a pre-defined topic T and provides the listing of users U_{T} as output 2402.

Subsequently, the pre-processing module 2403 is configured to provide a mapping from each user to a plurality of topic listings associated with the respective user at output 2404.

The text processing module 2405 is then configured to receive the listing of topics and associations with each user U_{T} such as to calculate an n-gram probability matrix based on a pre-defined segment size defined at the text processing module 2406. That is, in one aspect, the text processing module 2405 is configured to: for each user (U_{T}), provide each topic broken down into X segments Tᵢ->Tᵢ₁, Tᵢ₂, T_{iX} filter overlapping n-grams to define Tᵢ₁ . . . T_{if} n-grams for all users (U_{T}) and output n-gram probability matrix (output 2406) which defines probability for each user and each n-gram amongst all n-grams for all users. An exemplary output 1303 defined as: User 1: {Prob (U₁, Tᵢ₁) . . . Prob (U₁, T_{if})}; User 2: {Prob (U₂, T_{if})}. . . User T−1: {Prob (U_{T-1}, Tᵢ₁), . . . Prob (U_{T-1}, T_{if})}.

The clustering module 2407 thus receives a vector of n-gram TF-IDFs for each user U_{T}. The clustering module 2407 is then configured to map each user U_{T} into one of K clusters (e.g. user 1->C₁; User 2->C₁; . . . User T−1->Cₖ), as per output 2408.

The segment labelling module 2409 is then configured to provide at output 2410, the labelled segments for each cluster (e.g. C1->interest 1, #interest2 . . . Ck->#interestk). These labels may also be called topics or keywords.

With respect to the directional receiver module 608, it is appreciated that the active receiver is configured to narrow the scope of data being obtained. It is herein recognized that obtaining large amounts of data and then parsing or filtering through the same can be computationally intensive. It can be desirable to only obtain specific data to avoid downloading and storing large amounts of unnecessary data. A method performed by the directional receiver module 608 is used to help target the obtaining operations of the active receiver.

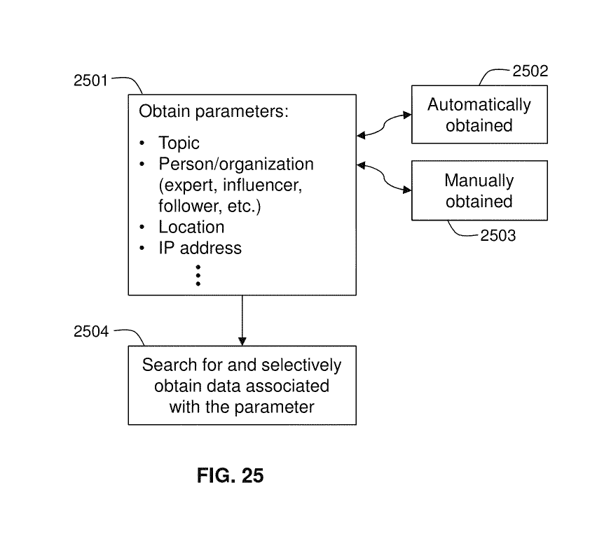

Turning to FIG. 25, the active receiver obtains parameters used to narrow down the search for data (block 2501). For example, the parameters include any one or more of a topic, a person or organization (e.g. expert, influencer, follower, a community, etc.), a location, a time range, a keyword or key phrase, and an IP address. Other parameters may be used as well. These parameters may be automatically obtained (block 2502). For example, the topics, the experts, the influencers, the followers, and the communities may be automatically obtained using any one or more of the operations performed associated with modules 604, 605, 606, and 607.

The parameters may also be manually obtained (block 2503), for example, using user input.

At block 2502, the active receiver uses the obtained parameters to search for and obtained data that is associated with the parameters.

For example, after establishing an influencer or an expert as a parameter, the active receiver actively obtains data related to the influencer or the expert. This related data, for example, includes: name, keywords used, common words used, followers, location, likes, dislikes, frequency of posts or messages, writing styles, language, etc. In an example embodiment, the active receiver does not obtain data from other users in the social network when obtaining data from the influencer or the expert, so as to narrow the scope of data being obtained.

In an example embodiment, when automatically obtaining the parameters, the parameters may be dynamically and automatically updated. For example, as the top influencers or the top experts for given topic change over time, so do the parameters associated with the top influencers or the top experts also change over time.

In another example, after establishing a location as a parameter, the active receiver only actively obtains data related to the given location. For example, message posts, article posts, tweet posts, etc. that originate from the given location are obtained, while other social data originating from other locations are not obtained.

In this way, social data associated with the parameter is selectively obtained and other data is ignored or intentionally not obtained. In other words, the operations to obtain the data are directed to specific targets.

With respect to the filter module 609, in an example aspect, the active receiver is configured to use the filter module to identify certain characteristics in the social data and amplify those characteristics. In another aspect, the active receiver uses the filter module to analyze the obtained social data and remove any anomalies.

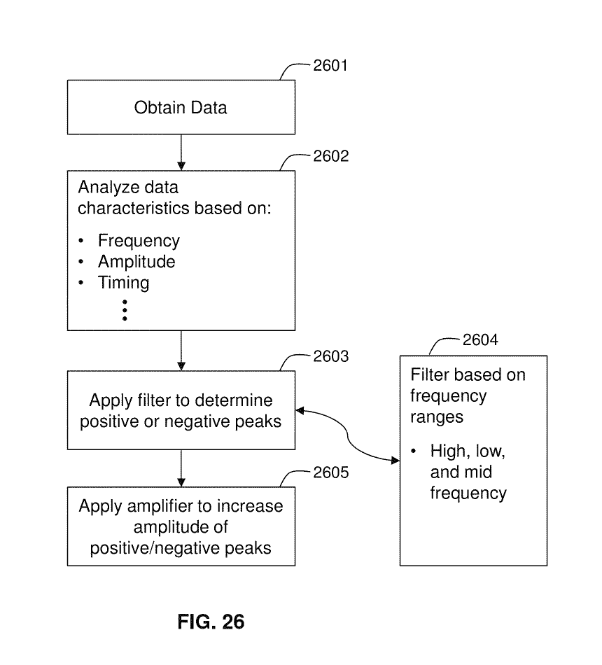

Turning to FIG. 26, example processor executable instructions are provided for filtering data to identify and amplify certain characteristics. This is beneficial to highlight certain meaning and content in the social data, which may be important or desirable, while ignoring the rest of the social data.

At block 2601 the social data is obtained. At block 2602, the active receiver analyzes the data based frequency, amplitude and timing. The frequency data or metaphor represents a certain social channel or plurality of social channels on the same social network or a plurality of several social channels spanning different social networks. The amplitude data or metaphor represents and characterizes the amount of activity (e.g. number of digital messages or number instances of a certain type of social data occurrence) on a certain social channel or a plurality of social channels on the same social network, or a plurality of social channels spanning different social networks. A social data occurrence may be characterized in different ways or based on different filters. For example, a social data occurrence may be a message from a certain type of user, or any message that uses a certain keyword, or a social data object originating from a certain location, or a social data object associated with a brand or a company.

It can be appreciated other ways for characterizing a social data occurrence can be used. The timing data or metaphor represents different dimensions of the frequency activity and or the amplitude activity. For example, the frequency or timing, or both, of the social data occurrences is tracked. Specifically there is more or less activity on certain social channels or a plurality of social channel activity on the same network or a plurality of social channel activity on different network activity—all at similar or opposite or recognizable patterns throughout the time of day. At block 2603, a singular or plurality of filter(s) is applied to determine positive or negative peaks (frequency peaks/valleys, amplitude peaks/valleys and timing peaks/valleys) in the data. A different filter could automatically machine learn peaks or valleys and automatically remove this data. The filter may be based on different frequency ranges or amplitude ranges, or both (block 2604). At block 2605, an amplifier process is applied to the amplitude of the positive or the negative peaks. Alternatively the amplifier could amplify data that was previously overshadowed by the distractive peak or valley information to hear the real signal amongst the distracting peaks and valleys in the social data. This exaggeration or amplification of the data helps the social communication system 102 to more readily identify the importance of the data.

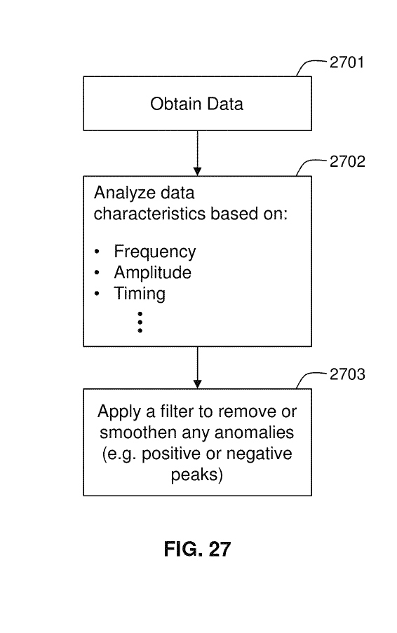

Turning to FIG. 27, example processor executable instructions are provided for filtering noise, including anomalies, in the social data. In this the way, the active receiver is able to output data and relationships that are more accurate. A non-limiting example of an anomaly in social data may include, for example, a topic that seem to be of interest to a certain group, but is not actually of interest to a group. Such an anomaly may be caused, for example, by many people using an ancillary topic keyword for a very short amount of time, while discussing a primary topic keyword over a longer or persistent period of time. The high number of instances of the use of the ancillary topic keyword is considered an anomaly, rather than a representation of a topic of interest. It is appreciated that other examples of anomalies are applicable and may be based on other characteristics, such as location, IP address, frequency, time range, users, communities, and relations between other users.

An example of noise in social data is when an expert or an influencer, or a group of users, regularly and frequently uses certain keywords and infrequently uses ancillary keywords. The infrequently used ancillary keywords may be considered as noise. It is appreciated that other examples of noise are applicable and may be based on other characteristics, such as location, IP address, frequency, time range, users, communities, and relations between other users.

At block 2701, the active receiver obtains the social data. It then analyzes the social data characteristics based on any one or more of frequency, amplitude, timing, etc (block 2702). At block 2703, the active receiver applies a filter to remove the noise or anomalies. For example, the active receiver removes any positive or negative peaks in the social data.

The process of FIG. 27 is a derivative of the content in FIG. 26, with an exception. The process of FIG. 26 is considered to be a “broadband receiver” constantly looking for patterns across frequency, amplitude, and time. By contrast, the process of FIG. 27 may be considered the inverse of the process of FIG. 26. In particular, in the process of FIG. 27, human or machine based key words, phrases, metadata etc. are inserted into the filter and applied to the social data to remove noise or anomalies.

With respect to the location and the topic correlator module 610, the active receiver is configured to use the module 610 identify and output relationships between different locations based on a similar topic or keyword.

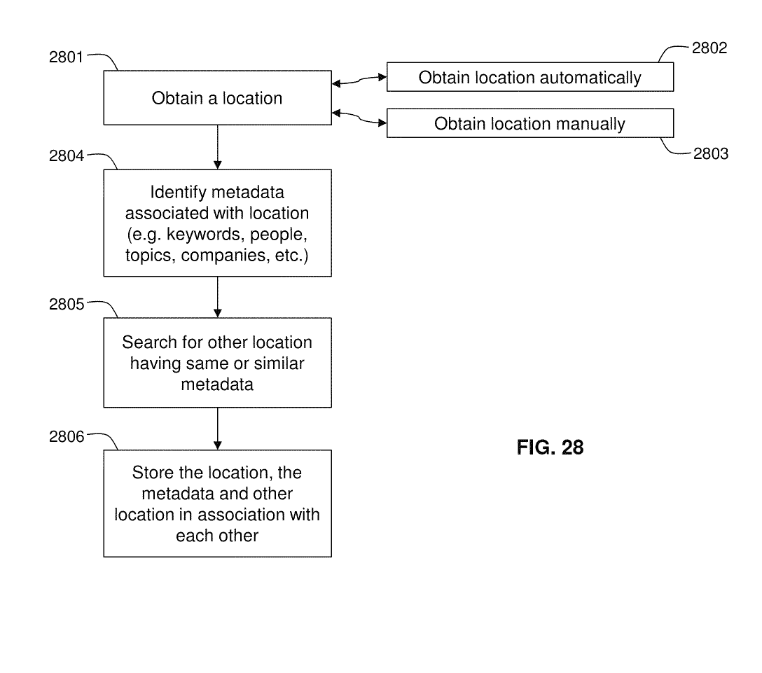

Turning to FIG. 28, example processor executable instructions are provided for performing operations according to the location and the topic module correlator 601, or more generally, via the active receiver. At block 2801, the active receiver obtains a location or multiple locations. The location or locations can have one or more forms, such as, for example, a country, a state or province, a region, a city, a village, an area, a demographic location, etc. The location may be obtained automatically (block 2802) or manually (block 2803). For example, when the location is obtained automatically, active receiver obtains the location based on metadata obtained in relation to an expert, an influencer, a community of influencers, or a segment of users. The location may also be automatically obtained based on pre-determined business intelligence of users or customers of the continuous social communication system 102 (e.g. location of users or customers, or location of their activity).

At block 2804, the active receiver identifies metadata associated with the location. Examples of such metadata include topics, keywords, key phrases, people, companies, etc. For example, if the obtained location (from block 2801) is the city of Toronto in Canada, a popular and commonly associated topic with Toronto is ‘mayor scandal’.

At block 2805, the active receiver searches for one or more other locations have the same or similar metadata. Continuing with the Toronto example, the active receiver searches for another location that is also commonly associated with the topic ‘mayor scandal’. The other location, in this example, is the city of San Diego in the United States.

At block 2806, the active receiver stores the location, the meta data and the other location in association with each other. Continuing with the Toronto example, the active receiver stores the relationship or associations between the location of Toronto, the location of San Diego and the common topic of ‘mayor scandal’.

It will be appreciated that such an association, for example, can be used to compose content that describes interesting relationships between different locations, based on a common topic (e.g. as per the active composer module 104). In another example, the relationship can also be used to determine to which different locations should social data be transmitted, based on common or shared meta data (e.g. as per the active transmitter module 105).

With respect to the data collaborator module 611, the active receiver is configured to use the module 611 to combine data from different data sources to form a more complete, or a complete data set. It is herein recognized that it is desirable to obtain may different types of data related to a specific topic, person, organization, location, user, or more generally, a specific subject. However, a single data source may not be able to provide all the different types of data, while other data sources may provide the missing types of data. The operations used according to the data collaborator module 611 can be used to address such problems.

In another aspect, the active receiver is configured to use the module 611 to obtain data from different sources to verify the data. In particular, it is herein recognized that data from a data source may not be reliable or correct. To verify that a data value for a certain data type is correct, the active receiver obtains the same data types from different data sources and compares the data values of the same data types.

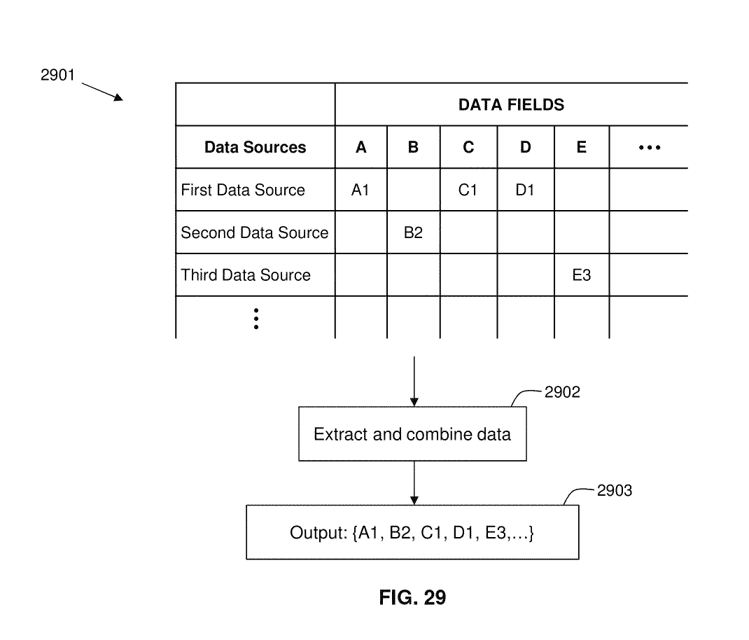

Turning to FIG. 29, an example is provided for combining data from different data sources to form a more complete, or a complete data set. In the graphical representation 2901, a set of data fields (e.g. A, B, C, D, E, etc.) are shown as being desired to be obtained by the active receiver. For example, the data fields may all relate to a certain subject, such as a person and non-limiting examples of the data fields for the person include name, age, location, email address, occupation, community or groups, and interests. As shown in the representation 2901, a first data source only can provide data values A1, C1 and D1 for the data fields A, C and D. In other words, the first data source is not able to provide data values for all the data fields, such as data fields B and E. A second data source only provides the data value B2 to populate the data field B and a third data source only provides the datable E3 to populate the data field E.

At block 2902, the active receiver extracts the data from these different data sources and combines the data. At block 2903, a more complete or a complete data set, in which the data fields are populated from the different data sources, is outputted. For example, the completed data set is {A1, B2, C1, D1, E3, . . . }.

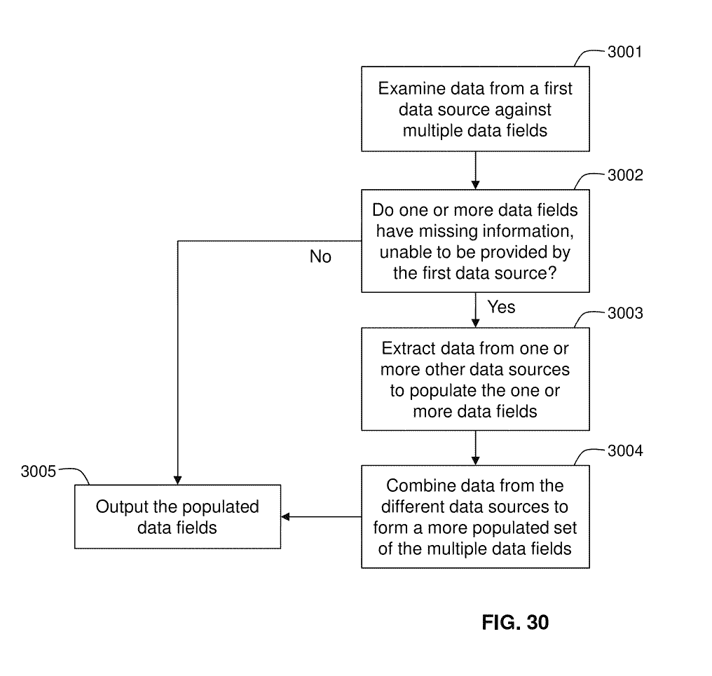

Turning to FIG. 30, example processor executable instructions are provide for combining data from different data sources to form a more complete, or a complete data set. These operations can be performed according to module 611, or more generally via the active receiver. At block 3001, the active receiver examines data from a first data source against multiple data fields. At block 3002, the active receiver determines if one or more data fields have missing information, which is unable to be provided by the first data source. If not, such as when the first data source provides data to populate all the data fields, then the process proceeds to block 3005 and the active receiver outputs the populated data fields.

However, if there is missing information in one or more data fields, then the active receiver extracts data from one or more other data sources to populate the one more data fields (block 3003). The active receiver then combines the data from the different data sources to form a more completely populated data set, or a completely populated data set, of the multiple data fields (block 3004).

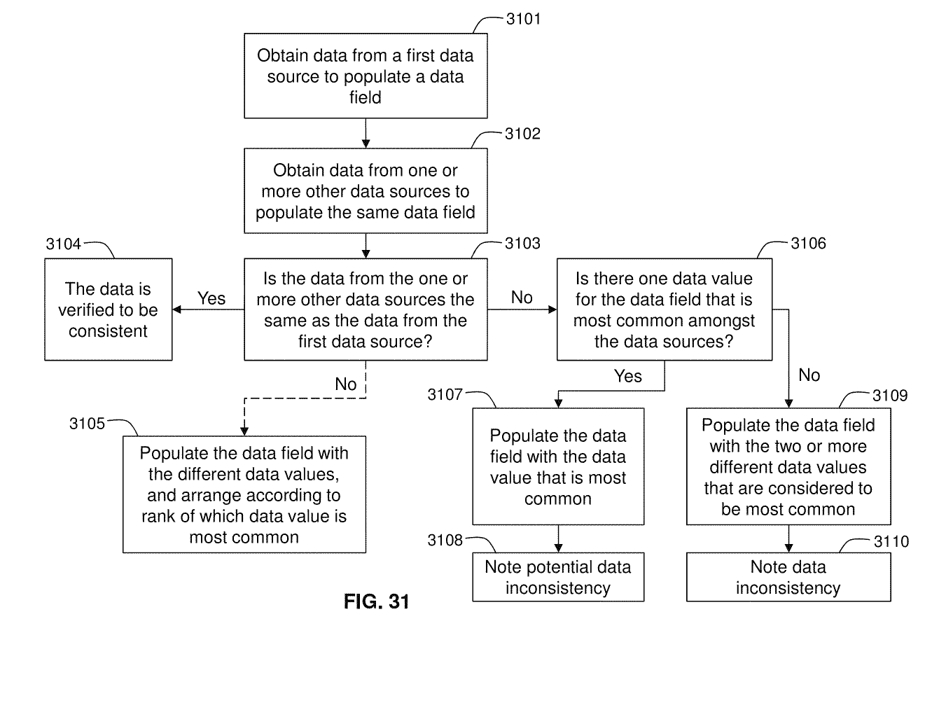

Turning to FIG. 31, example processor executable instructions are provided for filtering out noise, including anomalies, from social data. These instructions may be performed according to module 611, or more generally via the active receiver. At block 3101, the active receiver obtains data from a first data source to populate a data field. At block 3102, the active receiver obtains data from one or more other data sources to populate the same data field. At block 3103, the active receiver determines if the data from the one or more other data sources is the same as the data from the first data source. If so, at block 3104, the data is verified to be consistent.

If the data is not the same, then at block 3106, the active receiver determines if there is a data value for the date field that is most common amongst the data sources.

If there is a data value that is most common amongst the data sources, then the active receiver populates the data field with the data field that is most common (block 3107). A note about the potential data inconsistency is also made and associated with the data populated in the data field (block 3108). In this way, the system 102 or a user is aware that there is potential that the data is not correct.

In the alternative, continuing from block 3106, if there is no data value that is most common amongst the data sources, then there will be two or more different data values that are considered most common. These different data values are then used to populate the data field (block 3109). In other words, for the same data field, there are different data values. For example, a user's email address data field may be populated with different email addresses which are considered to be most common amongst the data sources. At block 3110, a note about the inconsistency in the data is made and associated with the data field and the data values. In this way, the system 102 or a user know that other data values for the same data field are possible.

In an alternative example embodiment, stemming from block 3103, if the data from the one or more other sources is not the same as the data from the first data source, then at block 3105, the active receiver populates the data field with the different data values. The different data values are ranked based on which data value is most common.

With respect to the prediction and the synthesizer module 612, the active receiver is configured to the module 612 to predict or synthesize, or both, one or more features related to an entity. A feature may be a characteristic related to an entity. A feature may also be an action that is predicted to be performed by an entity. A feature may also be an action that has been performed by an entity.

In particular, it is herein recognized that data about an entity may not be complete. However, using the prediction and synthesizer module 612, the active receiver is able to generate data about the entity, thereby making data about the entity more complete.

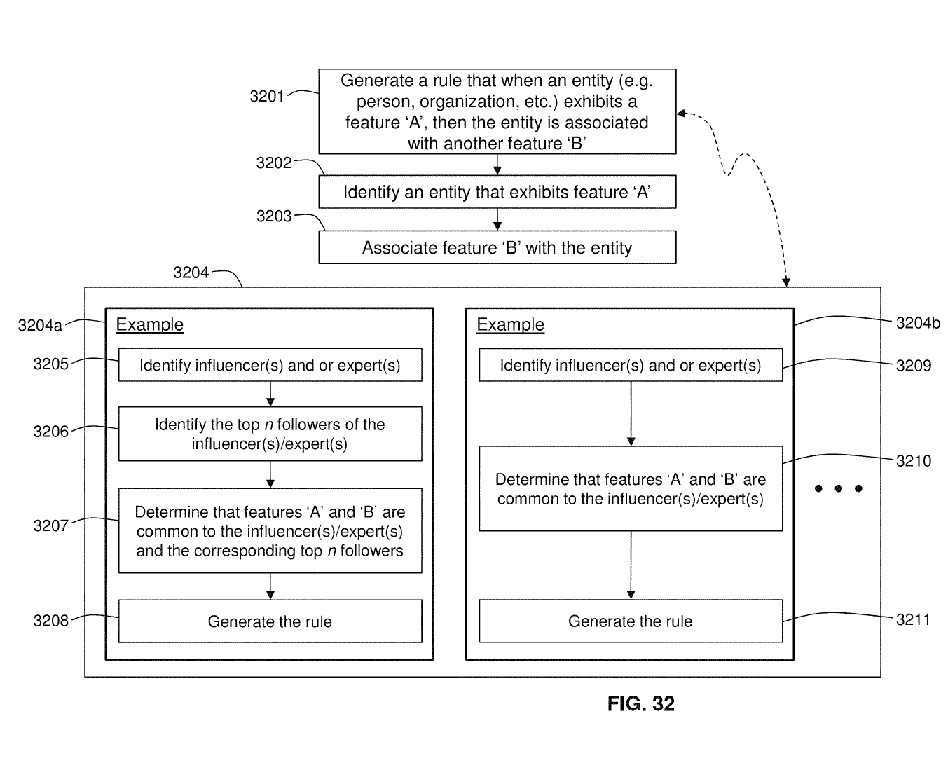

Turning to FIG. 32, example processor executable instructions are provided for predicting and synthesizing features. These instructions may be performed according to module 612, or more generally via the active receiver. At block 3201, the active receiver generates a rule that when an entity exhibits a feature ‘A’, then the entity is associated with another feature ‘B’. It will be appreciated that an entity may be a person, an organization, an account, a user, a group, a device, etc.

Non-limiting examples 3204 of generating such a rule are provided. An example 3204a includes identifying an influencer or an expert (block 3205), or multiples thereof. At block 3206, the active receiver identifies the top n followers of the influencer(s) or the expert(s). At block 3207, the active receiver determines that features ‘A’ and ‘B’ are common to the influencer(s) or the expert(s) and the common top n followers. At block 3208, the active receiver generates the rule that when an entity exhibits a feature ‘A’, the entity is associated with the other feature ‘B’.

Another example 3204b of generating the rule includes identifying an influencer or an expert (block 3209), or multiples thereof. At block 3210, the active receiver determines the features ‘A’ and ‘B’ are common to the influencer(s) or the expert(s). At block 3211, the active receiver generates the rule that when an entity exhibits a feature ‘A’, the entity is associated with the other feature ‘B’.

Continuing with FIG. 32, after generating the rule, at block 3202, the active receiver identifies an entity from the obtained data that exhibits feature ‘A’. At block 3203, the active receiver associates feature ‘B’ with the same entity.

In this way, although the entity has not exhibited feature ‘B’ and only feature ‘A’, the active receiver is configured to predict or synthesize that the entity is associated with feature ‘B’.

Other example aspects of the active receiver module are provided below.

The active receiver module 103 is configured to capture, in real time, one or more electronic data streams.

The active receiver module 103 is configured to analyse, in real time, the social data relevant to a business.

The active receiver module 103 is configured to translate text from one language to another language.

The active receiver module 103 is configured to interpret video, text, audio and pictures to create business information. A non-limiting example of business information is sentiment information. Sentiment information typically applies to whether a piece of social information is positive or negative. Consider the example social data: “I don't like Adidas shoes because my feet are wide and Adidas shoes are narrow”. In this example there is negative sentiment toward Adidas shoes.

Natural Language Processing (NLP) methods and algorithms are widely available both as open source (Ling Pipe) as well as commercially available (ClaraBridge). Social information can be entered into these NLP engines and output positive, neutral, or negative sentiment toward a social message.

The active receiver module 103 is configured to apply metadata to the received social data in order to provide further business enrichment. Non-limiting examples of metadata include geo data, temporal data, business driven characteristics, analytic driven characteristics, etc.

The active receiver module 103 is configured to interpret and predict potential outcomes and business scenarios using the received social data and the computed information. Determining and recommending potential event outcomes enables businesses to better forecast, reduce business risks, and make wiser decisions amongst a variety of possible outcomes. Using social information that has been collected, this data can be run through a Monte Carlo simulator. This computer intensive process can then output a variety of likely outcomes based on certain inputs. For example, if social networks are talking about the latest Adidas soccer shoe in Columbia, South America, Adidas could use Monte Carlo simulation to estimate the level of advertising money required to drive a certain purchase level.

The active receiver module 103 is configured to propose user segment or target groups based upon the social data and the metadata received. For example, the user and the segment groups are obtained by identifying experts and their followers. In another example, the users and the segments are obtained by identifying an influencer and their community or communities. In another example embodiment, the users and the segments are obtained by using any of the modules in the active receiver 103.

The active receiver module 103 is configured to propose or recommend social data channels that are positively or negatively correlated to a user segment or a target group.

The active receiver module 103 is configured to correlate and attribute groupings, such as users, user segments, and social data channels. In an example embodiment, the active receiver module uses patterns, metadata, characteristics and stereotypes to correlate users, user segments and social data channels.

The active receiver module 103 is configured to operate with little or no human intervention.

The active receiver module 103 is configured to assign affinity data and metadata to the received social data and to any associated computed data. In an example embodiment, affinity data is derived from affinity analysis, which is a data mining technique that discovers co-occurrence relationships among activities performed by (or recorded about) specific individuals, groups, companies, locations, concepts, brands, devices, events, and social networks.

### Active Composer Module

The active composer module 104 is configured to analytically compose and create social data for communication to people. This module may use business rules and apply learned patterns to personalize content. The active composer module is configured, for example, to mimic human communication, idiosyncrasies, slang, and jargon. This module is configured to evaluate multiple social data pieces or objects composed by itself (i.e. module 104), and further configured to evaluate ranks and recommend an optimal or an appropriate response based on the analytics. Further, the active composer module is able to integrate with other modules, such as the active receiver module 103, the active transmitter module 105, and the social analytic synthesizer module 106. The active composer module can machine-create multiple versions of a personalized content message and recommend an appropriate, or optimal, solution for a target audience.

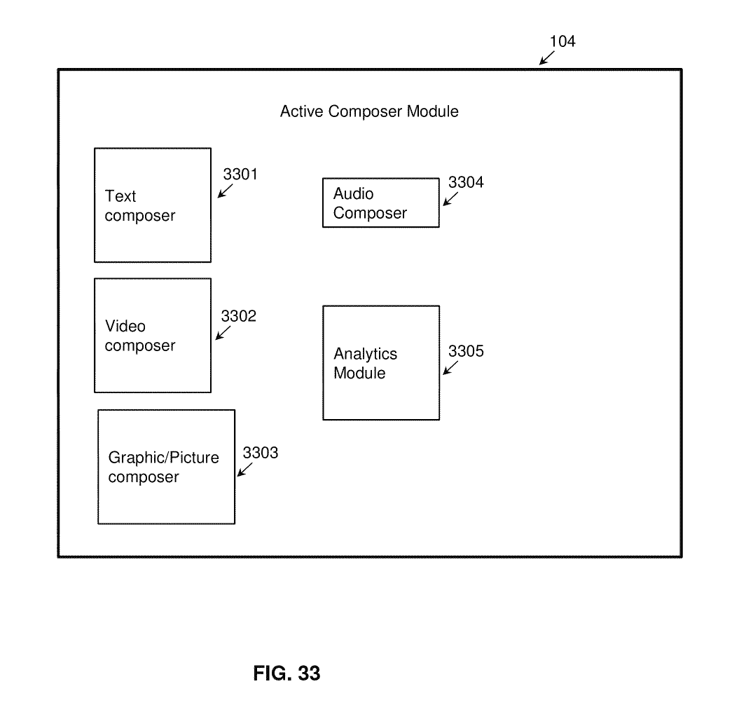

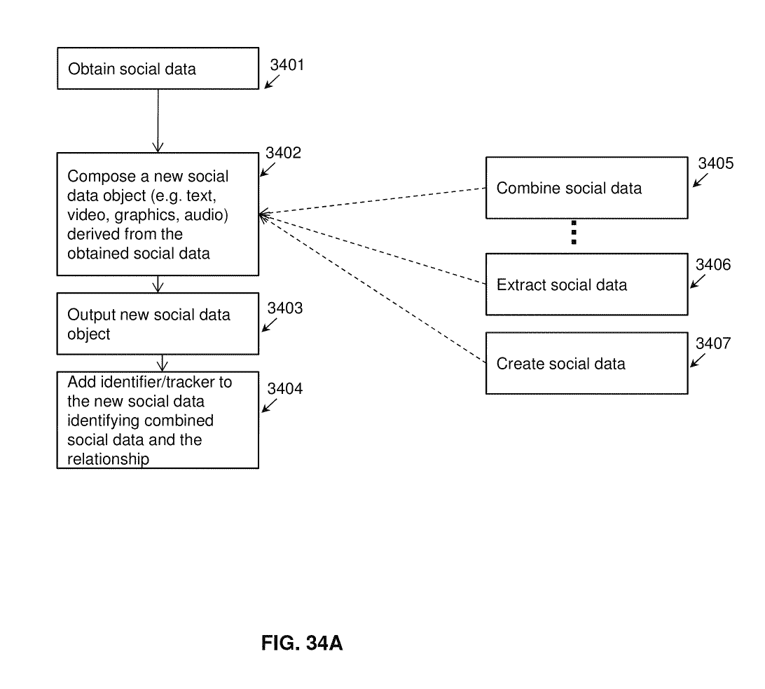

Turning to FIG. 33, example components of the active composer module 104 are shown. Example components include a text composer module 3301, a video composer module 3302, a graphics/picture composer module 3303, an audio composer 3304, and an analytics module 3305. The composer modules 3301, 3302, 3303 and 3304 can operate individually to compose new social data within their respective media types, or can operate together to compose new social data with mixed media types.

The analytics module 3305 is used to analyse the outputted social data, identify adjustments to the composing process, and generate commands to make adjustments to the composing process.

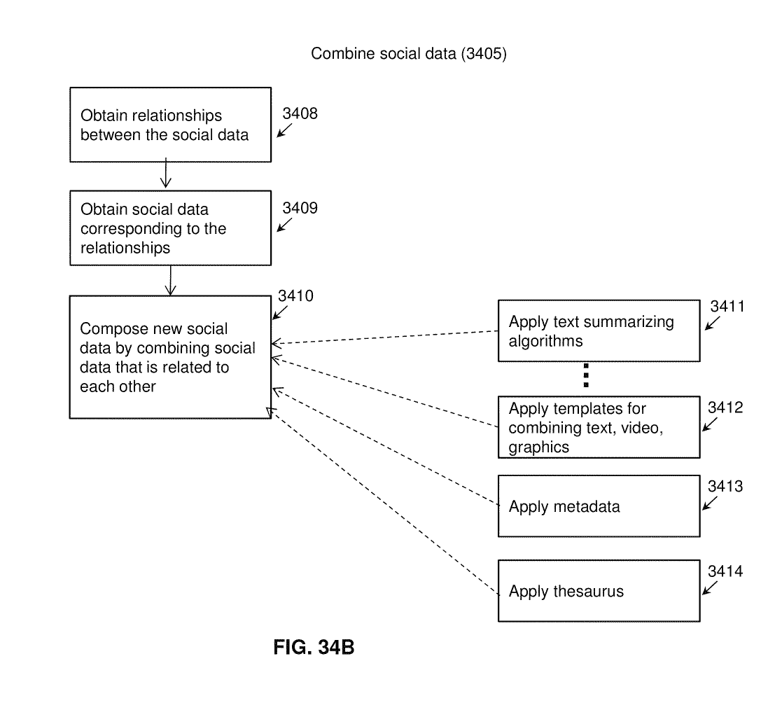

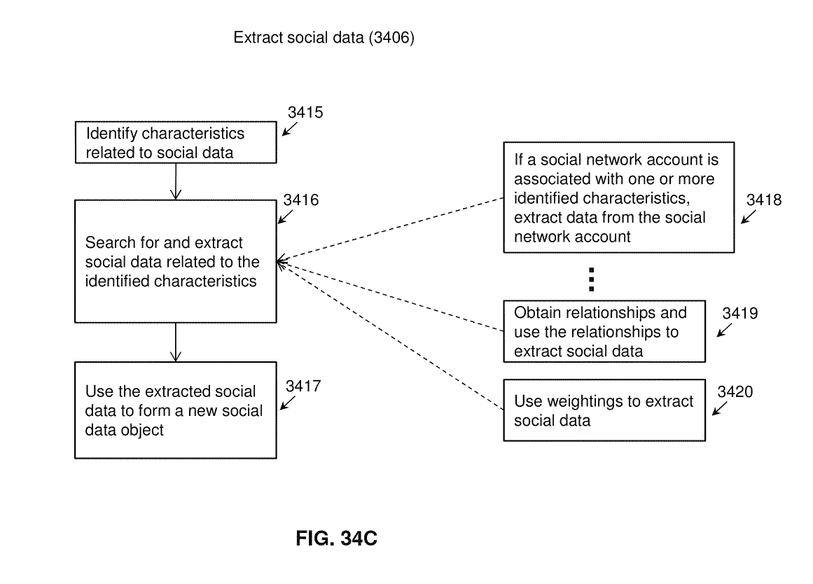

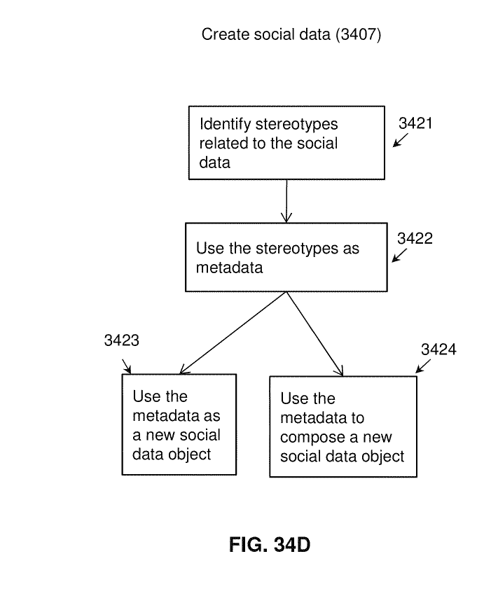

Turning to FIG. 34A, example computer or processor implemented instructions are provided for composing social data according the module 104. The active composer module obtains social data, for example from the active receiver module 103 (block 3401). The active composer module then composes a new social data object (e.g. text, video, graphics, audio) derived from the obtained social data (block 3402).

Various approaches can be used to compose the new social data object, or new social data objects. For example, social data can be combined to create the new social data object (block 3405), social data can be extracted to create the new social object (block 3406), and new social data can be created to form the new social data object (block 3407). The operations from one or more of blocks 3405, 3406 and 3407 can be applied to block 3402. Further details in this regard are described in FIGS. 34B, 34C and 34D.

Continuing with FIG. 34A, at block 3403, the active composer module outputs the composed social data. The active composer module may also add identifiers or trackers to the composed social data, which are used to identify the sources of the combined social data and the relationship between the combined social data (block 3404).

Turning to FIG. 34B, example computer or processor implemented instructions are provided for combining social data according to block 3405. The active composer module obtains relationships and correlations between the social data (block 3408). The relationships and correlations, for example, are obtained from the active receiver module. The active composer module also obtains the social data corresponding to the relationships (block 3409). The social data obtained in block 3409 may be a subset of the social data obtained by the active receiver module, or may be obtained by third party sources, or both. At block 3410, the active composer module composes new social data (e.g. a new social data object) by combining social data that is related to each other.

It can be appreciated that various composition processes can be used when implementing block 3410. For example, a text summarizing algorithm can be used (block 3411). In another example, templates for combining text, video, graphics, etc. can be used (block 3412). In an example embodiment, the templates may use natural language processing to generate articles or essays. The template may include a first section regarding a position, a second section including a first argument supporting the position, a third section including a second argument supporting the position, a fourth section including a third argument supporting the position, and a fifth section including a summary of the position. Other templates can be used for various types of text, including news articles, stories, press releases, etc.

Natural language processing catered to different languages can also be used. Natural language generation can also be used. It can be appreciated that currently know and future known composition algorithms that are applicable to the principles described herein can be used.

Natural language generation includes content determination, document structuring, aggregation, lexical choice, referring expression generation, and realisation. Content determination includes deciding what information to mention in the text. In this case the information is extracted from the social data associated with an identified relationship. Document structuring is the overall organisation of the information to convey. Aggregation is the merging of similar sentences to improve readability and naturalness. Lexical choice is putting words to the concepts. Referring expression generation includes creating referring expressions that identify objects and regions. This task also includes making decisions about pronouns and other types of anaphora. Realisation includes creating the actual text, which should be correct according to the rules of syntax, morphology, and orthography. For example, using “will be” for the future tense of “to be”.

Continuing with FIG. 34B, metadata obtained from the active receiver module, or obtained from third party sources, or metadata that has been generated by the system 102, may also be applied when composing the new social data object (block 3413). Furthermore, a thesaurus database, containing words and phrases that are synonymous or analogous to keywords and key phrases, can also be used to compose the new social data object (block 3414). The thesaurus database may include slang and jargon.

Turning to FIG. 34C, example computer or processor implemented instructions are provided for extracting social data according to block 3406. At block 3415, the active composer module identifies characteristics related to the social data. These characteristics can be identified using metadata, tags, keywords, the source of the social data, etc. At block 3416, the active composer module searches for and extracts social data that is related to the identified characteristics.

For example, one of the identified characteristics is a social network account name of a person, an organization, or a place. The active composer module will then access the social network account to extract data from the social network account. For example, extracted data includes associated users, interests, favourite places, favourite foods, dislikes, attitudes, cultural preferences, etc. In an example embodiment, the social network account is a LinkedIn account or a Facebook account. This operation (block 3418) is an example embodiment of implementing block 3416.

Another example embodiment of implementing block 3416 is to obtain relationships and use the relationships to extract social data (block 3419). Relationships can be obtained in a number of ways, including but not limited to the methods described herein. Another example method to obtain a relationship is using Pearson's correlation. Pearson's correlation is a measure of the linear correlation (dependence) between two variables X and Y, giving a value between +1 and −1 inclusive, where 1 is total positive correlation, 0 is no correlation, and −1 is negative correlation. For example, if given data X, and it is determined X and data Y are positively correlated, then data Y is extracted.

Another example embodiment of implementing block 3416 is to use weighting to extract social data (block 3420). For example, certain keywords can be statically or dynamically weighted based on statistical analysis, voting, or other criteria. Characteristics that are more heavily weighted can be used to extract social data. In an example embodiment, the more heavily weighted a characteristic is, the wider and the deeper the search will be to extract social data related to the characteristic.

Other approaches for searching for and extracting social data can be used.

At block 3417, the extracted social data is used to form a new social data object.

Turning to FIG. 34D, example computer or processor implemented instructions are provided for creating social data according to block 3407. At block 3421, the active composer module identifies stereotypes related to the social data. Stereotypes can be derived from the social data. For example, using clustering and decision tree classifiers, stereotypes can be computed.

In an example stereotype computation, a model is created. The model represents a person, a place, an object, a company, an organization, or, more generally, a concept. As the system 102, including the composer module, gains experience obtaining data and feedback regarding the social communications being transmitted, the active composer module is able to modify the model. Features or stereotypes are assigned to the model based on clustering. In particular, clusters representing various features related to the model are processed using iterations of agglomerative clustering. If certain of the clusters meet a predetermined distance threshold, where the distance represents similarity, then the clusters are merged. For example, the Jaccard distance (based on the Jaccard index), a measure used for determining the similarity of sets, is used to determine the distance between two clusters. The cluster centroids that remain are considered as the stereotypes associated with the model. For example, the model may be a clothing brand that has the following stereotypes: athletic, running, sports, swoosh, and ‘just do it’.

In another example stereotype computation, affinity propagation is used to identify common features, thereby identifying a stereotype. Affinity propagation is a clustering algorithm that, given a set of similarities between pairs of data points, exchanges messages between data points so as to find a subset of exemplar points that best describe the data. Affinity propagation associates each data point with one exemplar, resulting in a partitioning of the whole data set into clusters. The goal of affinity propagation is to minimize the overall sum of similarities between data points and their exemplars. Variations of the affinity propagation computation can also be used. For example, a binary variable model of affinity propagation computation can be used. A non-limiting example of a binary variable model of affinity propagation is described in the document by Inmar E. Givoni and Brendan J. Frey, titled “A Binary Variable Model of Affinity Propagation”, Neural Computation 21, 1589-1600 (2009), the entire contents of which are hereby incorporated by reference.

Another example stereotype computation is Market Basket Analysis (Association Analysis), which is an example of affinity analysis. Market Basket Analysis is a mathematical modeling technique based upon the theory that if you buy a certain group of products, you are likely to buy another group of products. It is typically used to analyze customer purchasing behavior and helps in increasing the sales and maintain inventory by focusing on the point of sale transaction data. Given a dataset, an apriori algorithm trains and identifies product baskets and product association rules. However, the same approach is used herein to identify characteristics of a person (e.g. stereotypes) instead of products. Furthermore, in this case, users' consumption of social data (e.g. what they read, watch, listen to, comment on, etc.) is analyzed. The apriori algorithm trains and identifies characteristic (e.g. stereotype) baskets and characteristic association rules.

Other methods for determining stereotypes can be used.

Continuing with FIG. 34D, the stereotypes are used as metadata (block 3422). In an example embodiment, the metadata is the new social data object (block 3423), or the metadata can be used to derive or compose a new social data object (block 3424).

It can be appreciated that the methods described with respect to blocks 3405, 3406 and 3407 to compose a new social data object can be combined in various way, though not specifically described herein. Other ways of composing a new social data object can also be applied.

In an example embodiment of composing a social data object, the social data includes the name “Chris Farley”. To compose a new social data object, social data is created using stereotypes. For example, the stereotypes ‘comedian’, ‘fat’, ‘ninja’, and ‘blonde’ are created and associated with Chris Farley. The stereotypes are then used to automatically create a caricature (e.g. a cartoon-like image of Chris Farley). The image of the person is automatically modified to include a funny smile and raised eye brows to correspond with the ‘comedian’ stereotype. The image of the person is automatically modified to have a wide waist to correspond with the ‘fat’ stereotype. The image of the person is automatically modified to include ninja clothing and weaponry (e.g. a sword, a staff, etc.) to correspond with the ‘ninja’ stereotype. The image of the person is automatically modified to include blonde hair to correspond with the ‘blonde’ stereotype. In this way, a new social data object comprising the caricature image of Chris Farley is automatically created. Various graphic generation methods, derived from text, can be used. For example, a mapping database contains words that are mapped to graphical attributes, and those graphical attributes in turn can be applied to a template image. Such a mapping database could be used to generate the caricature image.

In another example embodiment, the stereotypes are used to create a text description of Chris Farley, and to identify in the text description other people that match the same stereotypes. The text description is the composed social data object. For example, the stereotypes of Chris Farely could also be used to identify the actor “John Belushi” who also fits the stereotypes of ‘comedian’ and ‘ninja’. Although the above examples pertain to a person, the same principles of using stereotypes to compose social data also apply to places, cultures, fashion trends, brands, companies, objects, etc.

The active composer module 104 is configured to operate with little or no human intervention.

### Active Transmitter Module

The active transmitter module 105 analytically assesses preferred or appropriate social data channels to communicate the newly composed social data to certain users and target groups. The active transmitter module also assesses the preferred time to send or transmit the newly composed social data.

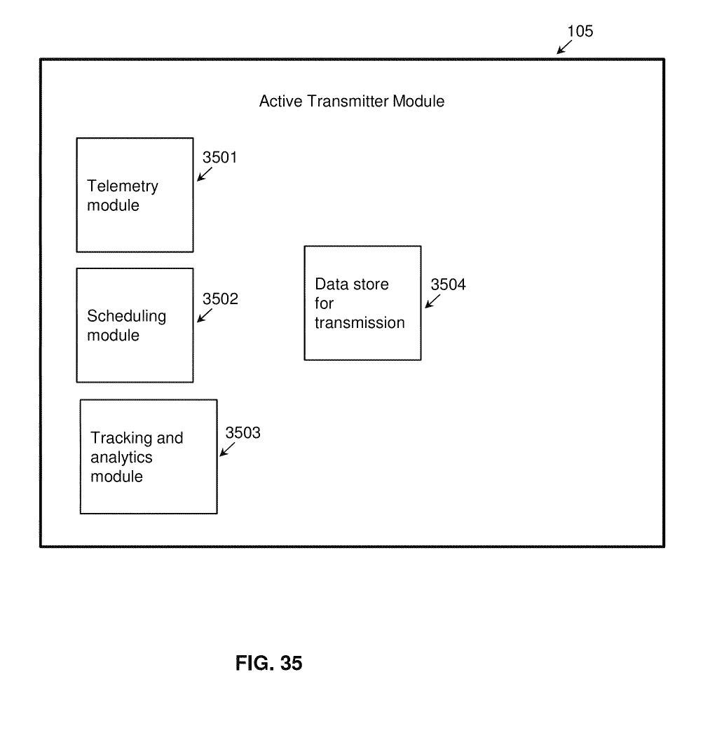

Turning to FIG. 35, example components of the active transmitter module 105 are shown. Example components include a telemetry module 3501, a scheduling module 3502, a tracking and analytics module 3503, and a data store for transmission 3504. The telemetry module 3501 is configured to determine or identify over which social data channels a certain social data object should be sent or broadcasted. A social data object may be a text article, a message, a video, a comment, an audio track, a graphic, or a mixed-media social piece. For example, a social data object about a certain car brand should be sent to websites, RSS feeds, video or audio channels, blogs, or groups that are viewed or followed by potential car buyers, current owners of the car brand and past owners of the car brand. The scheduling module 3502 determines a preferred time range or date range, or both, for sending a composed social data object. For example, if a newly composed social data object is about stocks or business news, the composed social data object will be scheduled to be sent during working hours of a work day. The tracking and analytics module 3503 inserts data trackers or markers into a composed social data object to facilitate collection of feedback from people. Data trackers or markers include, for example, tags, feedback (e.g. like, dislike, ratings, thumb up, thumb down, etc.), number of views on a web page, etc.

The data store for transmission 3504 stores a social data object that has the associated data tracker or marker. The social data object may be packaged as a “cart”. Multiple carts, having the same social data object or different social data objects, are stored in the data store 3504. The carts are launched or transmitted according to associated telemetry and scheduling parameters. The same cart can be launched multiple times. One or more carts may be organized under a campaign to broadcast composed social data. The data trackers or markers are used to analyse the success of a campaign, or of each cart.

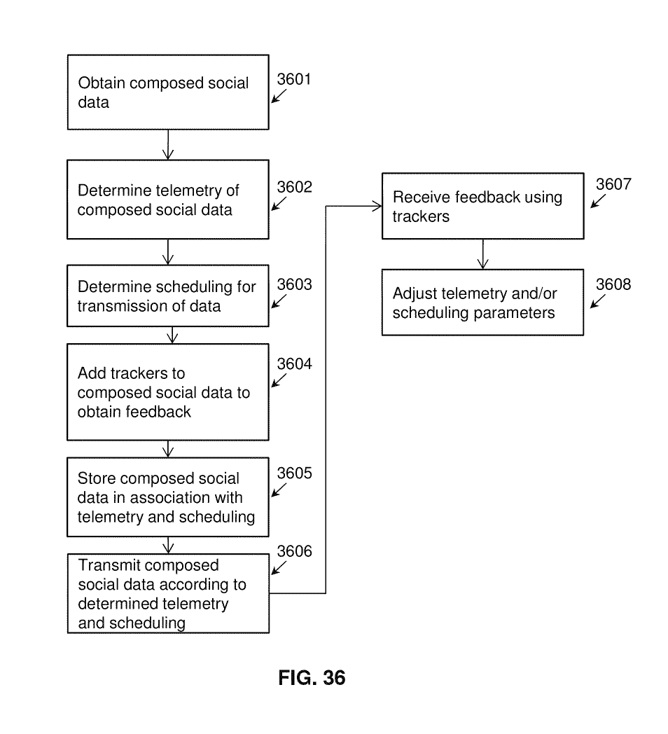

Turning to FIG. 36, example computer or processor implemented instructions are provided for transmitting composed social data according the active transmitter module 105. At block 3601, the active transmitter module obtains the composed social data. At block 3602, the active transmitter module determines the telemetry of the composed social data. At block 3603, the active transmitter module determines the scheduling for the transmission of the composed social data. Trackers, which are used to obtain feedback, are added to the composed social data (block 3604), and the social data including the trackers are stored in association with the scheduling and telemetry parameters (block 3605). At the time determined by the scheduling parameters, the active transmitter module sends the composed social data to the identified social data channels, as per the telemetry parameters (block 3606).

Continuing with FIG. 36, the active transmitter module receives feedback using the trackers (block 3607) and uses the feedback to adjust telemetry or scheduling parameters, or both (block 3608).

Other example aspects of the active transmitter module 105 are provided below.

The active transmitter module 105 is configured to transmits messages and, generally, social data with little or no human intervention

The active transmitter module 105 is configured to uses machine learning and analytic algorithms to select one or more data communication channels to communicate a composed social data object to an audience or user(s). The data communication channels include, but are not limited to, Internet companies such as FaceBook, Twitter, and Bloomberg. Channel may also include traditional TV, radio, and newspaper publication channels.

The active transmitter module 105 is configured to automatically broaden or narrow the target communication channel(s) to reach a certain target audience or user(s).

The active transmitter module 105 is configured to integrate data and metadata from third party companies or organizations to help enhance channel targeting and user targeting, thereby improving the effectiveness of the social data transmission.

The active transmitter module 105 is configured to apply and transmit unique markers to track composed social data. The markers track the effectiveness of the composed social data, the data communication channel's effectiveness, and ROI (return on investment) effectiveness, among other key performance indicators.

The active transmitter module 105 is configured to automatically recommend the best time or an appropriate time to send/transmit the composed social data.

The active transmitter module 105 is configured to listen and interpret whether the composed social data was successfully received by the data communication channel(s), or viewed/consumer by the user(s), or both.

The active transmitter module 105 is configured to analyse the user response of the composed social data and automatically make changes to the target channel(s) or user(s), or both. In an example, the decision to make changes is based on successful or unsuccessful transmission (receipt by user).

The active transmitter module 105 is configured to filter out certain data communication channel(s) and user(s) for future or subsequent composed social data transmissions.

The active transmitter module 105 is configured to repeat the transmission of previously sent composed social data for N number of times depending upon analytic responses received by the active transmitter module. The value of N in this scenario may be analytically determined.

The active transmitter module 105 is configured to analytically determine a duration of time between each transmission campaign.

The active transmitter module 105 is configured to apply metadata from the active composer module 104 to the transmission of the composed social data, in order to provide further business information enrichment. The metadata includes, but is not limited to, geo data, temporal data, business driven characteristics, unique campaign IDs, keywords, hash tags or equivalents, analytic driven characteristics, etc.

The active transmitter module 105 is configured to scale in size, for example, by using multiple active transmitter modules 105. In other words, although one module 105 is shown in the figures, there may be multiple instances of the same module to accommodate large scale transmission of data.

### Social Analytic Synthesizer Module

The social analytic synthesizer module 106 is configured to perform machine learning, analytics, and to make decisions according to business driven rules. The results and recommendations determined by the social analytic synthesizer module 106 are intelligently integrated with any one or more of the active receiver module 103, the active composer module 104, and the active transmitter module 105, or any other module that can be integrated with the system 102. This module 106 may be placed or located in a number of geo locations, facilitating real time communication amongst the other modules. This arrangement or other arrangements can be used for providing low latency listening, social content creation and content transmission on a big data scale.

The social analytic synthesizer module 106 is also configured to identify unique holistic patterns, correlations, and insights. In an example embodiment, the module 106 is able to identify patterns or insights by analysing all the data from at least two other modules (e.g. any two or more of modules 103, 104 and 105), and these patterns or insights would not have otherwise been determined by individually analysing the data from each of the modules 104, 104 and 105. The feedback or an adjustment command is provided by the social analytic synthesizer module 106, in an example embodiment, in real time to the other modules. Over time and over a number of iterations, each of the modules 103, 104, 105 and 106 become more effective and efficient at continuous social communication and at their own respective operations.

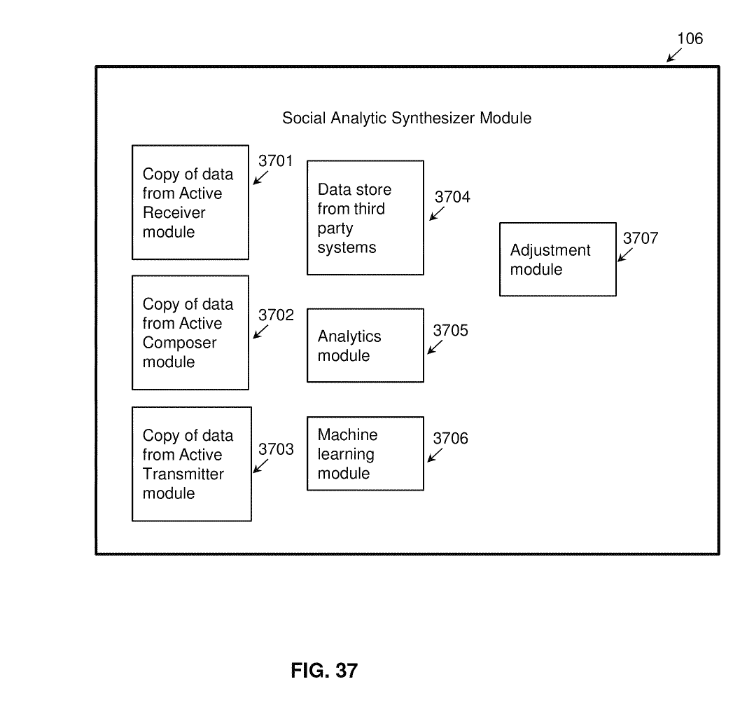

Turning to FIG. 37, example components of the social analytic synthesizer module 106 are shown. Example components include a copy of data from the active receiver module 3701, a copy of data from the active composer module 3702, and a copy of data from the active transmitter module 3703. These copies of data include the inputted data obtained by each module, the intermediary data, the outputted data of each module, the algorithms and computations used by each module, the parameters used by each module, etc. Preferably, although not necessarily, these data stores 3701, 3702 and 3703 are updated frequently. In an example embodiment, the data from the other modules 103, 104, 105 are obtained by the social analytic synthesizer module 106 in real time as new data from these other modules become available.

Continuing with FIG. 37, example components also include a data store from a third party system 3704, an analytics module 3705, a machine learning module 3706 and an adjustment module 3707. The analytics module 3705 and the machine learning module 3706 process the data 3701, 3702, 3703, 3704 using currently known and future known computing algorithms to make decisions and improve processes amongst all modules (103, 104, 105, and 106). The adjustment module 3707 generates adjustment commands based on the results from the analytics module and the machine learning module. The adjustment commands are then sent to the respective modules (e.g. any one or more of modules 103, 104, 105, and 106).

In an example embodiment, data from a third party system 3704 can be from another social network, such as LinkedIn, Facebook, Twitter, etc.

Other example aspects of the social analytic synthesizer module 106 are below.

The social analytic synthesizer module 106 is configured to integrate data in real time from one or more sub systems and modules, included but not limited to the active receiver module 103, the active composer module 104, and the active transmitter module 105. External or third party systems can be integrated with the module 106.

The social analytic synthesizer module 106 is configured to apply machine learning and analytics to the obtained data to search for “holistic” data patterns, correlations and insights.

The social analytic synthesizer module 106 is configured to feed back, in real time, patterns, correlations and insights that were determined by the analytics and machine learning processes. The feedback is directed to the modules 103, 104, 105, and 106 and this integrated feedback loop improves the intelligence of each module and the overall system 102 over time.

The social analytic synthesizer module 106 is configured to scale the number of such modules. In other words, although the figures show one module 106, there may be multiple instances of such a module 106 to improve the effectiveness and response time of the feedback.

The social analytic synthesizer module 106 is configured to operate with little or no human intervention.

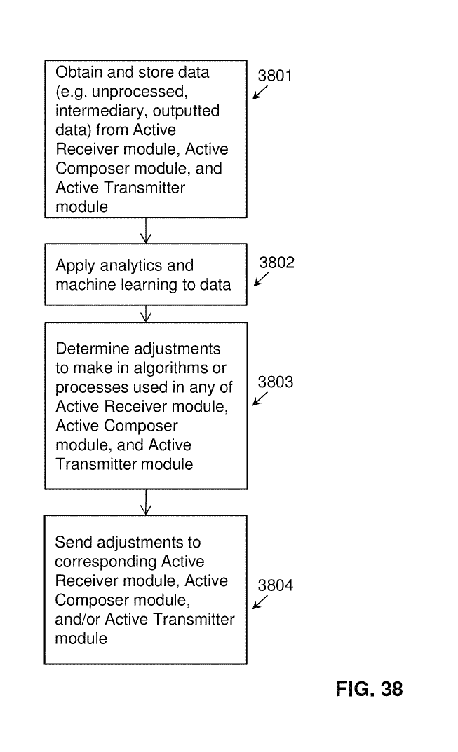

Turning to FIG. 38, example computer or processor implemented instructions are provided for analysing data and providing adjustment commands based on the analysis, according to module 106. At block 3801, the social analytic synthesizer module obtains and stores data from the active receiver module, the active composer module and the active transmitter module. Analytics and machine learning are applied to the data (block 3802). The social analytic synthesizer determines adjustments to make in the algorithms or processes used in any of the active receiver module, active composer module, and the active transmitter module (block 3803). The adjustments, or adjustment commands, are then sent to the corresponding module or corresponding modules (block 3804).

General example embodiments of the systems and methods are described below.

In general, a method performed by a computing system for obtaining social data, includes: obtaining social data from one or more data streams; filtering the social data to obtain filtered social data; analysing the filtered social data to determine one or more relationships; and outputting the filtered social data and the relationship in association with each other.

In an aspect of the method, the method further includes composing new social data using the social data and the relationships.

In another aspect of the method, the method further includes identifying one or more users based on the relationship and transmitting the new social data to the one or more users.

In another aspect of the method, after obtaining the social data, which comprises text, the method further includes translating the text from one language to another language.

In another aspect of the method, the method further includes assigning affinity data to the social data and to any associated computed data, such as the relationship, wherein the affinity data is derived from affinity analysis.

In another aspect of the method, determining the one or more relationships includes identifying an influencer amongst a group of users for a topic, wherein the filtered social data includes the group of users and the topic.

In another aspect of the method, the one or more relationships further includes a relationship between the influencer and a community of users associated with the topic, the community of users being a subset of the group of users, and the method further comprises identifying popular characteristics of the community.

In another aspect of the method, determining the influencer includes determining a number of instances in which one or more users perform any one or more of the following: mentioning the influencer, replying to the influencer, and re-posting content from the influencer.

In another aspect of the method, the social data includes users and text associated with the users, and wherein determining the one or more relationships includes: performing n-gram text processing on the text to determine the one more relationships between different users.

In another aspect of the method, the method further includes obtaining one or more parameters and selectively obtaining the social data only associated with the one or more parameters.

In another aspect of the method, filtering the social data includes: analyzing the social data based on frequency, amplitude and timing of activity of social data occurrences; applying a filter to determine a positive or a negative peak in the social data; and amplifying the positive or the negative peak.

In another aspect of the method, the social data includes location data and meta data associated with the location data, and determining the one or more relationships includes: identifying meta data associated with a first location; identifying another location associated with other meta data that is same or similar to the meta data associated with the first location; and generating an association between the first location, the second location, the meta data associated with the first location, and the meta data associated with the second location.

In another aspect of the method, the social data is obtained from a data source, and the method includes: comparing the social data against multiple data fields to determine that there is missing data not provided by the data source; obtaining the missing data from one or more other data sources; and combining the social data from the data source and the missing data from the one or more other data sources to populate the multiple data fields.

In another aspect of the method, the social data includes a data value obtained from a first data source to populate a data field, and includes one or more other data values obtained from one or more other data sources to populate the data field; and the method further includes: determine that the data value and the one or more other data values are different; and using a most common data value amongst the data value and the one or more other data values to populate the data field.

In another aspect of the method, the method further includes: when identifying that an entity in the social data exhibits a first feature, synthesizing that a second feature is associated with the entity.

In another aspect of the method, the method further includes, when identifying that an entity in the social data exhibits a feature, predicting that the entity will perform an action.

In another aspect of the method, the one or more relationships are defined between at least two concepts, the concepts including any combination of a topic, multiple topics, a brand, multiple brands, a company, multiple companies, a person, people, a location, multiple locations, a date, multiple dates, a keyword, and multiple keywords.

In general, another method performed by a computing device for communicating social data, includes: obtaining social data; deriving at least two concepts from the social data; determining a relationship between the at least two concepts; composing a new social data object using the relationship; transmitting the new social data object; obtaining user feedback associated with new social data object; and computing an adjustment command using the user feedback, wherein executing the adjustment command adjusts a parameter used in the method.

In an aspect of the method, an active receiver module is configured to at least obtain the social data, derive the least two concepts from the social data, and determine the relationship between the at least two concepts; an active composer module is configured to at least compose the new social data object using the relationship; an active transmitter module is configured to at least transmit the new social data object; and wherein the active receiver module, the active composer module and the active transmitter module are in communication with each other.

In an aspect of the method, each of the active receiver module, the active composer module and the active transmitter module are in communication with a social analytic synthesizer module, and the method further includes the social analytic synthesizer module sending the adjustment command to at least one of the active receiver module, the active composer module and the active transmitter module.

In an aspect of the method, the method further includes executing the adjustment command and repeating the method.

In an aspect of the method, obtaining the social data includes the computing device communicating with multiple social data streams in real time.

In an aspect of the method, determining the relationship includes using a machine learning algorithm or a pattern recognition algorithm, or both.

In an aspect of the method, composing the new social data object includes using natural language generation.

In an aspect of the method, the method further includes determining a social communication channel over which to transmit the new social data object, and transmitting the new social data object over the social communication channel, wherein the social communication channel is determined using at least one of the at least two concepts.

In an aspect of the method, the method further includes determining a time at which to transmit the new social data object, and transmitting the new social data object at the time, wherein the time is determined using at least one of the at least two concepts.

In an aspect of the method, the method further includes adding a data tracker to the new social data object before transmitting the new social data object, wherein the data tracker facilitates collection of the user feedback.

In an aspect of the method, the new social data object is any one of text, a video, a graphic, audio data, or a combination thereof.

It will be appreciated that different features of the example embodiments of the system and methods, as described herein, may be combined with each other in different ways. In other words, different modules, operations and components may be used together according to other example embodiments, although not specifically stated.

The steps or operations in the flow diagrams described herein are just for example. There may be many variations to these steps or operations without departing from the spirit of the invention or inventions. For instance, the steps may be performed in a differing order, or steps may be added, deleted, or modified.

Although the above has been described with reference to certain specific embodiments, various modifications thereof will be apparent to those skilled in the art without departing from the scope of the claims appended hereto.

1. A method performed by a computing system for obtaining social data, comprising:
obtaining social data from one or more data streams;
filtering the social data to obtain filtered social data;
analysing the filtered social data to determine one or more relationships; and
outputting the filtered social data and the one or more relationships in association with each other.

2. The method of claim 1 further comprising composing new social data using the social data and the one or more relationships.

3. The method of claim 2 further comprising identifying one or more users based on the one or more relationships and transmitting the new social data to the one or more users.

4. The method of claim 1 further comprising, after obtaining the social data, which comprises text, translating the text from one language to another language.

5. The method of claim 1 further comprising assigning affinity data to the social data and to any associated computed data, such as the relationship, wherein the affinity data is derived from affinity analysis.

6. The method of claim 1 wherein determining the one or more relationships includes identifying an influencer amongst a group of users for a topic, wherein the filtered social data includes the group of users and the topic.

7. The method of claim 6 wherein the one or more relationships further comprises a relationship between the influencer and a community of users associated with the topic, the community of users being a subset of the group of users, and the method further comprises identifying popular characteristics of the community.

8. The method of claim 6 wherein determining the influencer comprises determining a number of instances in which one or more users perform any one or more of the following: mentioning the influencer, replying to the influencer, and re-posting content from the influencer.

9. The method of claim 1 wherein the social data includes users and text associated with the users, and wherein determining the one or more relationships comprises: performing n-gram text processing on the text to determine the one more relationships between different users.

10. The method of claim 1 further comprising obtaining one or more parameters and selectively obtaining the social data only associated with the one or more parameters.

11. The method of claim 1 wherein filtering the social data comprises: analyzing the social data based on frequency, amplitude and timing of activity of social data occurrences; applying a filter to determine a positive or a negative peak in the social data; and amplifying the positive or the negative peak.

12. The method of claim 1 wherein the social data comprises location data and meta data associated with the location data, and determining the one or more relationships comprises: identifying meta data associated with a first location; identifying another location associated with other meta data that is same or similar to the meta data associated with the first location; and generating an association between the first location, the second location, the meta data associated with the first location, and the meta data associated with the second location.

13. The method of claim 1 wherein the social data is obtained from a data source, and the method comprising: comparing the social data against multiple data fields to determine that there is missing data not provided by the data source; obtaining the missing data from one or more other data sources; and combining the social data from the data source and the missing data from the one or more other data sources to populate the multiple data fields.

14. The method of claim 1 wherein the social data comprises a data value obtained from a first data source to populate a data field, and comprises one or more other data values obtained from one or more other data sources to populate the data field; and the method further comprising: determine that the data value and the one or more other data values are different; and using a most common data value amongst the data value and the one or more other data values to populate the data field.

15. The method of claim 1 further comprising: when identifying that an entity in the social data exhibits a first feature, synthesizing that a second feature is associated with the entity.

16. The method of claim 1 further comprising, when identifying that an entity in the social data exhibits a feature, predicting that the entity will perform an action.

17. The method of claim 1 wherein the one or more relationships are defined between at least two concepts, the concepts comprising any combination of a topic, multiple topics, a brand, multiple brands, a company, multiple companies, a person, people, a location, multiple locations, a date, multiple dates, a keyword, and multiple keywords.

18. A server system configured to obtain social data, comprising:
a processor;
a communication device;
a memory device; and
wherein the memory device comprises computer executable instructions for at least:
obtaining social data from one or more data streams;
filtering the social data to obtain filtered social data;
analysing the filtered social data to determine one or more relationships; and
outputting the filtered social data and the one or more relationships in association with each other.
